(19) United States
(12) Patent Application Publication
(10) Pub. No.: US 2019/0102738 A1
(43) Pub. Date: Apr. 4, 2019

(54) ANALYSIS APPARATUS FOR RECEPTION INFORMATION AND ANALYSIS METHOD FOR RECEPTION INFORMATION

(71) Applicant: FUJITSU LIMITED, Kawasaki-shi (JP)

(72) Inventor: Masatoshi Takamiya, Nagoya (JP)

(73) Assignee: FUJITSU LIMITED, Kawasaki-shi (JP)

(21) Appl. No.: 16/139,224

(22) Filed: Sep. 24, 2018

(30) Foreign Application Priority Data
Sep. 29, 2017 (JP) 2017-191267

(51) Int. Cl. G06Q 10/10; G06Q 30/00; G06F 17/30

(52) U.S. Cl. CPC G06Q 10/10; G06F 17/3071; G06Q 30/016

(57) ABSTRACT

An analysis apparatus includes one or more memories configured to store a plurality of pieces of reception information and a plurality of pieces of maintenance information in association with each other, each of the plurality of pieces of reception information including inquiry information on an information processing system and answer information created to the inquiry information, each of the plurality of pieces of maintenance information representing contents of a maintenance operation performed on the information processing system, and one or more processors configured to perform identifying a number N which indicates how many pieces of reception information are associated with first maintenance information which is stored in association with first reception information in the one or more memories, and perform calculation of an evaluation value of the first reception information on the basis of the identified number N.

### CROSS-REFERENCE TO RELATED APPLICATION

This application is based upon and claims the benefit of priority of the prior Japanese Patent Application No. 2017-191267, filed on Sep. 29, 2017, the entire contents of which are incorporated herein by reference.

### FIELD

The embodiments discussed herein are related to an analytical technique for reception information.

### BACKGROUND

In a call center where inquiries on information processing services from users (clients) are accepted, the operator responds to the inquiries. At this time, the operator is able to refer to knowledge based on contents of previously accepted inquiries and contents of answers thereto, and consider contents of a proper answer to the inquiry.

The knowledge may be useful information shared in organizations, and examples of the knowledge referred to by the operator include frequently asked questions (FAQ). The FAQ may be offered to the operator as well as the user.

Generally, the knowledge is manually registered. For example, reception information containing contents of previous inquiries and answers is stored as records, and the reception information stored in the records is analyzed to select the reception information containing contents suited to be registered as the knowledge. However, such manual operation requests much manpower, and has a low working efficiency.

Thus, a technique of assisting the knowledge register operation by use of a computer has been proposed. For example, in a proposed knowledge registration system, contents of client reception are stored as reception records, and based on the presence/absence of implementation of knowledge search at the client reception, and the presence/absence of use of the search result for the client reception, a knowledge registration candidate is extracted from the reception contents in the reception records. Further, in a proposed FAQ creation system, combinations of a plurality of documents that describe explanations of individual phenomena and countermeasures against individual situations, and questions that request the documents as answers are stored to create the FAQ including frequently asked questions and answers thereto.

For example, Japanese Laid-open Patent Publication Nos. 2007-272414 and 2003-030224 disclose related arts.

### SUMMARY

According to an aspect of the invention, an analysis apparatus includes one or more memories configured to store a plurality of pieces of reception information and a plurality of pieces of maintenance information in association with each other, each of the plurality of pieces of reception information including inquiry information on an information processing system and answer information created to the inquiry information, each of the plurality of pieces of maintenance information representing contents of a maintenance operation performed on the information processing system, and one or more processors configured to perform identifying a number N which indicates how many pieces of reception information are associated with first maintenance information which is stored in association with first reception information in the one or more memories, and perform calculation of an evaluation value of the first reception information on the basis of the identified the number N, the evaluation value indicating suitability of registration of the reception information as knowledge.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of a configuration and processing of an information processor according to First embodiment;

FIG. 2 is a view illustrating an example of a configuration of an operation management system according to Second embodiment;

FIG. 3 is a view for describing user support processing;

FIG. 4 is a view illustrating an example of a hardware configuration of an analysis server;

FIG. 5 is a block diagram illustrating an example of configurations of processing functions of an operation management server and the analysis server;

FIG. 6 is a view illustrating the processing of registering a change request ticket;

FIG. 7 is a view illustrating an example of a data structure of a change request database;

FIG. 8 is a view illustrating an example of an answer creation screen;

FIG. 9 is a view illustrating an example of a data structure of an incident database;

FIG. 10 is a view illustrating an example of a data structure of a relation database;

FIG. 11 is a view illustrating an example of the registration of relation data in the case where answer information is created using another answer information;

FIG. 12 is a view illustrating an example of the display on an association screen;

FIG. 13 is a view illustrating an example of the registration of relation data in the case where an incident ticket is associated with a change request ticket;

FIG. 14 is a view illustrating an example of the display on a forwarding screen;

FIG. 15 is a flow chart illustrating an example of processing of registering the incident ticket;

FIG. 16 is a view illustrating an example of processing of calculating a quoted number;

FIG. 17 is a view illustrating an example of processing of counting the number of incident tickets related to a particular system change operation;

FIG. 18 is a view illustrating an example of the calculation of a diversion ratio;

FIG. 19 is a flow chart illustrating an example of processing of the analysis server (1);

FIG. 20 is a flow chart illustrating an example of processing of the analysis server (2);

FIG. 21 is a flow chart illustrating an example of processing of the analysis server (3);

FIG. 22 is a flow chart illustrating an example of processing of the analysis server (4);

FIG. 23 is a view illustrating an example of the display on an analysis result screen; and

FIG. 24 is a view illustrating an example of the display on a ticket content display screen.

### DESCRIPTION OF EMBODIMENTS

A knowledge registration operation may be assisted by a computer to improve its efficiency to some extent. However, according to the conventional technique, the accuracy of automatically detecting a registration candidate for knowledge from previous reception information by use of the computer is not sufficiently high.

Embodiments of the present disclosure will be described below with reference to figures.

### First Embodiment

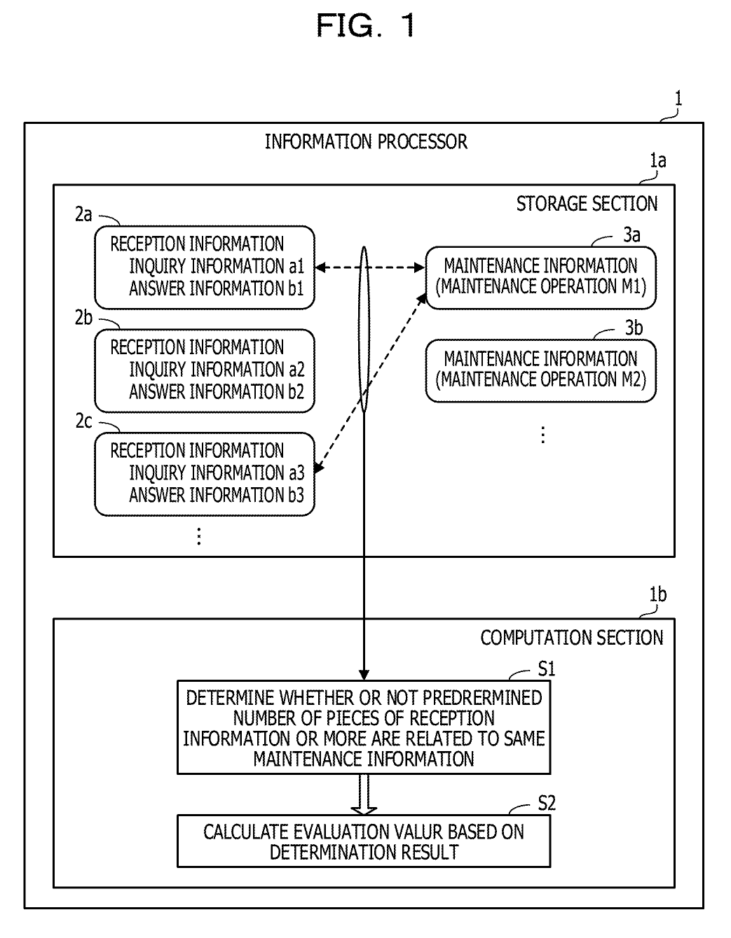

FIG. 1 is a view illustrating an example of a configuration and processing of an information processor according to First embodiment. The information processor 1 illustrated in FIG. 1 includes a storage section 1a and a computation section 1b. For example, the storage section 1a is embodied as storage area of a storage device such as a random access memory (RAM) and a hard disk drive (HDD). For example, the computation section 1b is embodied as a processor.

The storage section 1a stores a plurality of pieces of reception information 2a, 2b, 2c, . . . . The pieces of reception information 2a, 2b, 2c, . . . each contain inquiry information on an information processing system not illustrated, and answer information made in response to the inquiry information. In the example illustrated in FIG. 1, the reception information 2a contains inquiry information a1 and answer information b1, the reception information 2b contains inquiry information a2 and answer information b2, and reception information 2c contains inquiry information a3 and answer information b3.

The pieces of reception information 2a, 2b, 2c, . . . contain inquiry information previously accepted from the users of the information processing system, and answer information corresponding to the inquiry information. The reception information 2a, 2b, 2c, . . . may be information collected from a server that accepts inquiries from the users of the information processing system (for example, a server of a call center).

The storage section 1a stores maintenance information 3a, 3b, . . . . The maintenance information 3a, 3b, . . . represents contents of maintenance operations performed on the information processing system. In the example illustrated in FIG. 1, the maintenance information 3a represents contents of a maintenance operation M1, and the maintenance information 3b represents contents of a maintenance operation M2. The maintenance information 3a, 3b, . . . may be stored in another device located external to the information processor 1.

For each of the pieces of reception information 2a, 2b, 2c, . . . stored in the storage section 1a, the computation section 1b calculates an evaluation value representing the suitability for a knowledge registration candidate. As an example, the processing of calculating the evaluation value of the reception information 2a will be described below.

The computation section 1b determines whether or not a predetermined number of pieces of reception information or more including the reception information 2a among the reception information 2a, 2b, 2c, . . . stored in the storage section 1a are related to the same maintenance information among the maintenance information 3a, 3b, . . . (Step S1). Here, it is assumed that the pieces of reception information 2a, 2c are related to the maintenance information 3a. The predetermined number for determination is set to “2”. In this case, in determination processing in Step S1, since it is determined that the predetermined number of pieces of reception information or more including the reception information 2a are related to the same maintenance information 3a, a determination condition is satisfied.

Based on the determination result in Step S1, the computation section 1b calculates the evaluation value of the reception information 2a (Step S2). For example, when the determination condition is satisfied, the computation section 1b determines that the reception information 2a has the suitability for the knowledge registration candidate, and increases the evaluation value of the reception information 2a. In this case, the computation section 1b may increase the evaluation value of the reception information 2a as well as the reception information 2c related to the same maintenance information 3a. On the contrary, when the determination condition is not satisfied, the computation section 1b keeps the evaluation value of the reception information 2a as it is.

Here, some inquiry information transmitted from the user of the information processing system may contain contents related to a particular maintenance operation. For example, a particular maintenance operation may temporarily degrade processing performances of the information processing system, possibly lowering the response speed to the user's operation or interrupting connection. In this case, a lot of users transmit the inquiry information to inquire countermeasures against the above-mentioned phenomena. That is, in such case, a lot of pieces of inquiry information related to the particular maintenance operation are transmitted, and a lot of pieces of reception information each including the inquiry information are stored.

As described above, when the many pieces of reception information are related to the particular maintenance operation, the reception information is desirably shared among knowledge among users and operators (respondents). That is, the users may share the knowledge, and solve their problem based on the knowledge by themselves. Alternatively, the operators may share the knowledge, and refer to useful information at answering, to improve the working efficiency and quality of the operators.

Accordingly, in Step S2, the computation section 1b may calculate the evaluation value based on the determination result in Step S1 to enhance the correctness of the evaluation value, thereby improving the accuracy of evaluating the suitability.

According to the above-mentioned procedure, the computation section 1b calculates the evaluation value of each piece of reception information 2a, 2b, 2c, . . . , and outputs the reception information having the highest evaluation value, or a predetermined number of pieces of reception information in decreasing order of the evaluation value, as the knowledge registration candidates. The knowledge registration candidates are output by being displayed on a display. The operator who performs the knowledge registration operation may create knowledge (for example, FAQ) based on the reception information output as the knowledge registration candidates, and register the knowledge in a predetermined knowledge storage section. The computation section 1b may automatically register the reception information that is the knowledge registration candidate, as the knowledge.

### Second Embodiment

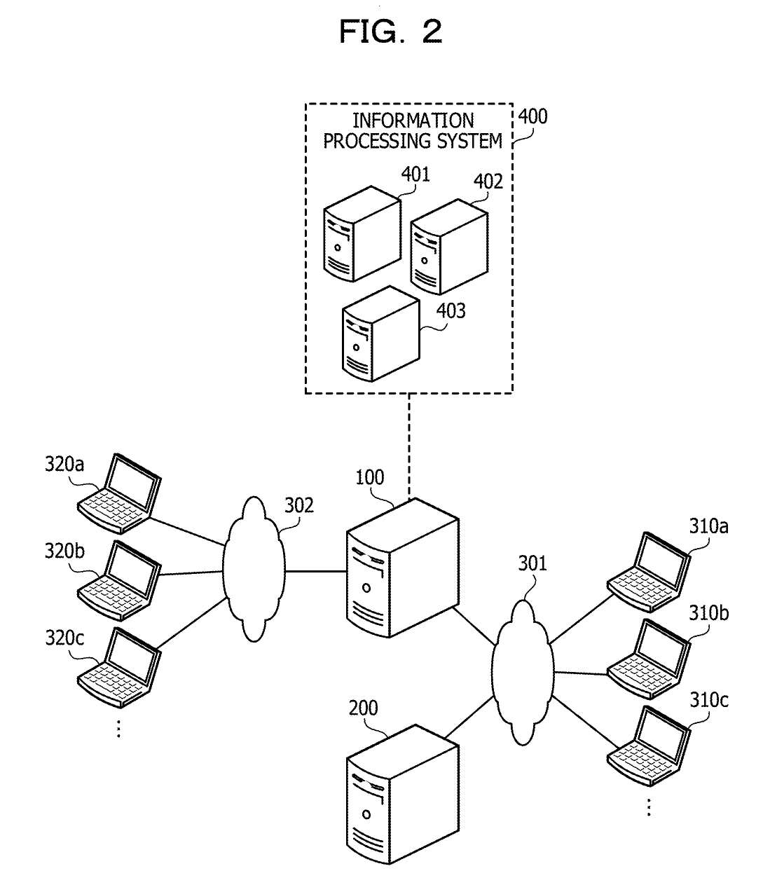

FIG. 2 is a view illustrating an example of a configuration of an operation management system according to Second embodiment. The operation management system illustrated in FIG. 2 includes an operation management server 100 and an analysis server 200. The operation management server 100 is connected to the analysis server 200 via a network 301.

The operation management server 100 is a server that manages the operation of information processing services offered to the user using an information processing system 400. Terminal devices 310a, 310b, 310c, . . . operated by the manager who manages the operation of information processing services are connected to the operation management server 100.

For example, the operation management server 100 collects event information on various events occurred in the information processing system 400 from the information processing system 400, and stores the event information. In the example illustrated in FIG. 2, the information processing system 400 includes servers 401 to 403, and the operation management server 100 collects the event information from each of the servers 401 to 403, and stores the event information. The manager may use any of the terminal devices 310a, 310b, 310c, . . . to view contents of the stored event information.

The operation management server 100 manages contents and implementation schedule of the maintenance operations performed on the information processing system 400. For example, the operation management server 100 executes the processing of accepting an application of the maintenance operation from the manager, or the processing of approving an application by another manager having an approval authority and registering contents and implementation schedule of applied maintenance operation. The manager may use any of the terminal devices 310a, 310b, 310c, . . . to apply and approve the maintenance operations.

Examples of the maintenance operations include an inspection operation and a system change operation. Examples of the system change operation include the replacement and installation of a server, and the installation and updating of a program.

Further, the operation management server 100 executes user support processing as one kind of operation management processing. The user support processing is the processing for offering desired information to the user who wants to obtain knowledge on information processing services. In this embodiment, such services include the viewing of FAQ and the acceptance of inquiries from the user.

Terminal devices 320a, 320b, 320c, . . . operated by the user are connected to the operation management server 100 via a network 302. The user may receive services realized by the user support processing via any of terminal devices 320a, 320b, 320c, . . . . The manager may refer to the event information stored as mentioned above to create a proper answer to the user's inquiry and respond to the user.

The analysis server 200 executes the processing of assisting the operation of creating the FAQ offered from the operation management server 100.

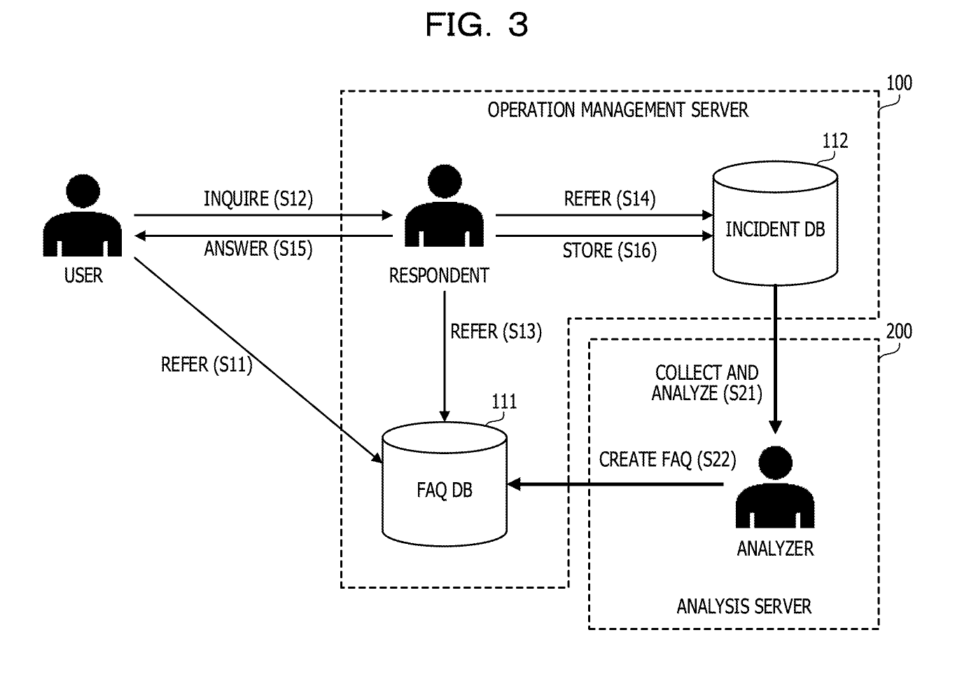

Here, FIG. 3 is a view for describing the user support processing. With reference to FIG. 3, the user support processing and FAQ creation assistance processing will be further described below.

The operation management server 100 includes a FAQ database (DB) 111 that stores a lot of FAQs. The FAQs stored in the FAQ database 111 each is information making a pair of contents of the inquiry and contents of the answer thereto.

The user of the information processing services may use any of the terminal devices 320a, 320b, 320c, . . . to access the operation management server 100. When wanting to obtain knowledge on the usage of the information processing services, trouble shooting and so on, the user may refer to the FAQs stored in the FAQ database 111 (Step S11). For example, the operation management server 100 accepts an input of a search keyword from the user, extracts the FAQs including the search keyword in inquiries or answers from the FAQ database 111, and presents the extracted FAQs to the user.

When the user may not acquire desired information by referring to the FAQ database 111, the user may make an inquiry to the operation management server 100 (Step S12). In this case, the inquiry information on the contents of the inquiry is transmitted to the operation management server 100. For example, the contents of the inquiry information are described in the form of a question.

The inquiry is answered by a person in charge of answer among managers who manage the operation of the information processing services. Hereinafter the person in charge of answer is referred to as “respondent”. The respondent accesses the operation management server 100 from any of the terminal devices 310a, 310b, 310c, . . . to create the answer information on the answer to the inquiry. For example, the contents of the answer information are described in the form of an answer.

The operation management server 100 has a function of assisting an answer creation operation performed by the respondent. For example, at the creation of the answer information, the respondent may refer to the FAQ database 111 (Step S13). In this case, the operation management server 100 accepts an input of a search keyword from the respondent, extracts FAQs including the search keyword in inquiries or answers from the FAQ database 111, and presents the FAQs to the respondent. Alternatively, the operation management server 100 may analyze contents of the accepted inquiry, extract FAQs including a proper answer to the contents of the inquiry from the FAQ database 111, and present the FAQs to the respondent.

In the operation management server 100, the acceptance event of the inquiry from the user is handled as “incident” occurred in the operation management system. Then, contents of previously accepted inquiries and answers thereto are stored in a data structure called an “incident ticket”, and the incident tickets are stored in an incident database (DB) 112.

At the creation of the answer information, the respondent may refer to contents of previous incidents stored in the incident database 112 (Step S14). In this case, the operation management server 100 analyzes the contents of the accepted inquiry, extracts the incident ticket including a proper answer to the inquiry from the incident database 112, and presents the incident ticket to the respondent.

As described later, the respondent may also quote at least a portion of the answer information included in the presented incident ticket, and create the answer information to the accepted inquiry information. When the answer information is quoted, information on the quotation relationship between the incident tickets is recorded in the operation management server 100.

When the respondent completes the answer information creation operation, the answer information is transmitted from the operation management server 100 to the user (Step S15). At this time, the operation management server 100 stores the incident ticket including contents of the accepted inquiry information and contents of the answer information in the incident database 112 (Step S16).

Next, a FAQ creation operation will be described with reference to FIG. 3.

In this embodiment, the FAQ registered in the FAQ database 111 is created based on the incident tickets stored in the incident database 112. That is, the FAQ is created as information to be shared among a lot of users and respondents as the knowledge, among information on the previously occurred incidents.

A person in charge of creation of FAQ (hereinafter referred to as “analyzer”) among the managers who manage the operation of the information processing services analyzes contents of the incident tickets registered in the incident database 112 to distinguish the incident ticket deemed to be suitable as being registered as the FAQ. The analyzer uses the inquiry information and the answer information in the distinguished incident ticket as it is, or edits at least a portion of the information to create a FAQ, and registers the FAQ in the FAQ database 111.

According to the analysis operation of the analyzer, the incident ticket including desirable contents to be shared among users and respondents is identified from previous incident tickets, and a FAQ is created based on contents of the identified incident tickets. This increases the probability that the user may obtain desired information at the reference to the FAQ database 111. As a result, on the side of the provider of the information processing services, the number of inquiries issued from the user to the operation management server 100 may be decreased to reduce costs of persons and physical resources for responding to the inquiry. Further, the respondent may refer to the FAQ database 111 to increase the probability of obtaining useful information for the answer, improving the working efficiency of the respondent.

However, the operation of analyzing contents of a large number of incident tickets stored in the incident database 112 by the analyzer has a high load and is not so efficient. Thus, the analysis server 200 calculates the level of suitability for the registration of each of the incident tickets stored in the incident database 112 as the FAQ, and presents the incident tickets in decreasing order of the level of suitability to the analyzer.

To calculate the level of suitability, the analysis server 200 collects information related to contents of the stored incident tickets from the incident database 112 of the operation management server 100, and analyzes the collected information (Step S21). The collected information contains, for example, the above-mentioned quotation relationship between the incident tickets. Then, the analysis server 200 uses a lot of determination references based on the collected information to accurately calculate the level of suitability.

The analyzer may determine whether or not only the incident ticket having a high level of suitability is registered as the FAQ to create the FAQ (Step S22). By narrowing down the target in this manner, the working loads of the analyzer may be reduced to improve the working efficiency.

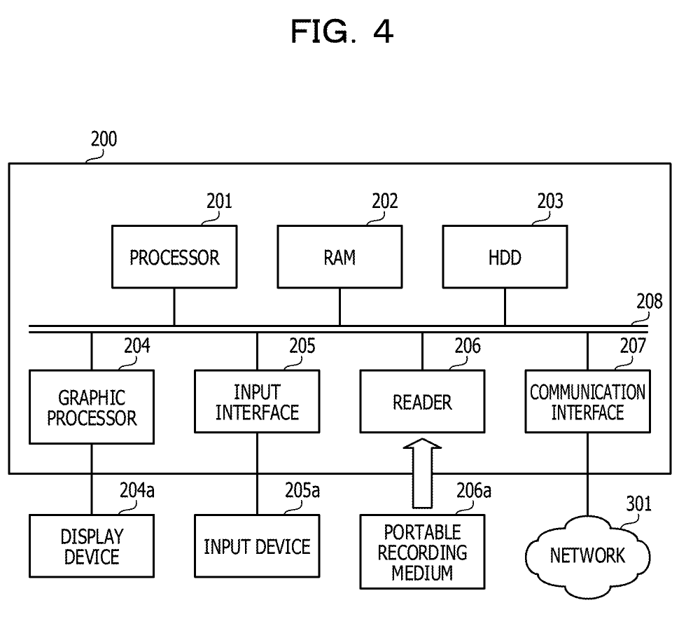

FIG. 4 is a view illustrating an example of a hardware configuration of the analysis server. For example, the analysis server 200 is embodied as a computer as illustrated in FIG. 4.

The analysis server 200 is controlled by a processor 201 as a whole. The processor 201 may be a multi-processor. Examples of the processor 201 include a central processing unit (CPU), a micro processing unit (MPU), a digital signal processor (DSP), an application specific integrated circuit (ASIC), and a programmable logic device (PLD). The processor 201 may be a combination of two or more elements including CPU, MPU, DSP, ASIC, and PLD.

A RAM 202 and a plurality of peripheral devices are connected to the processor 201 via a bus 208.

The RAM 202 is used as a main memory of the analysis server 200. The RAM 202 temporarily stores at least a part of an operating system (OS) program and an application program, which are executed by the processor 201. The RAM 202 stores various types of desired data for processing of the processor 201.

The peripheral devices connected to the bus 208 are an HDD 203, a graphic processor 204, an input interface 205, a reader 206, and a communication interface 207.

The HDD 203 is used as an auxiliary memory of the analysis server 200. The HDD 203 stores an OS program, an application program, and various types of data. Any other type of nonvolatile memory such as a solid state drive (SSD) may be used as the auxiliary memory.

A display device 204a is connected to the graphic processor 204. In response to an instruction from the processor 201, the graphic processor 204 displays images on the display device 204a. Examples of the display device 204a include a liquid crystal display and an organic electroluminescence (EL) display.

An input device 205a is connected to the input interface 205. The input interface 205 transmits a signal output from the input device 205a to the processor 201. Examples of the input device 205a include a keyboard and a pointing device. Examples of the pointing device include a mouse, a touch panel, a tablet, a touch pad, and a track ball.

A portable recording medium 206a is removed from/attached to the reader 206. The reader 206 reads data recorded in the portable recording medium 206a, and transmits the data to the processor 201. Examples of the portable recording medium 206a include an optical disc, a magneto-optical disc, and a semiconductor memory.

The communication interface 207 transmits/receives data to/from other devices such as the operation management server 100 and the terminal devices 310a, 310b, 310c, . . . via a network 301.

The above-mentioned hardware configuration may achieve the processing functions of the analysis server 200.

The operation management server 100 may be also embodied as the computer having the hardware configuration as illustrated in FIG. 4.

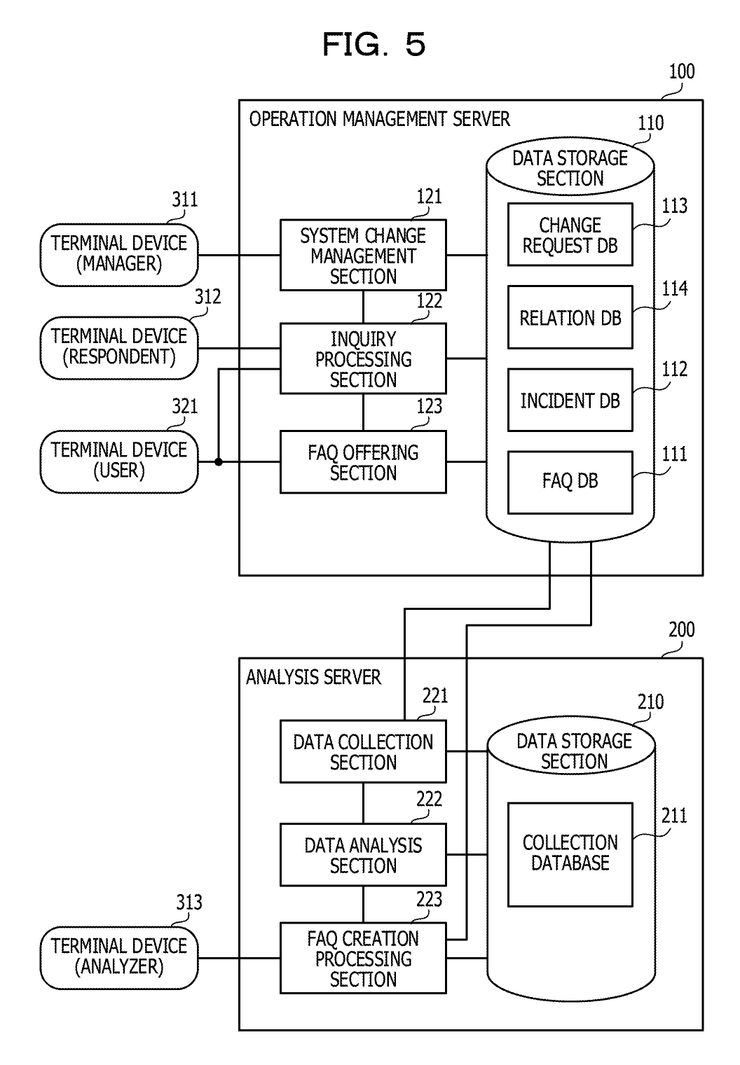

FIG. 5 is a block diagram illustrating an example of configuration of processing functions of the operation management server and the analysis server.

First, the operation management server 100 has a data storage section 110, a system change management section 121, an inquiry processing section 122, and a FAQ offering section 123. The data storage section 110 stores a change request database (DB) 113 and a relation database (DB) 114 in addition to the FAQ database 111 and the incident database 112.

For example, the data storage section 110 is embodied as a storage area of a storage device of the operation management server 100. The processing of the system change management section 121, the inquiry processing section 122, and the FAQ offering section 123 is executed by causing the processor of the operation management server 100 to perform a predetermined application program.

The system change management section 121 manages processes for the application and the approval of the system change operation. The system change operation is the operation accompanied with a change of the system configuration, among the maintenance operations of the information processing system 400. Examples of the system change operation include the replacement and the installation of a server, and the installation and the updating of a program.

When a certain manager applies the system change operation, the system change management section 121 creates a data structure called a “change request ticket” that stores contents, and implementation schedule of the operation. The system change management section 121 forwards the created change request ticket to one or more other managers having the approval authority. When receiving an approval, the system change management section 121 registers the approved change request ticket in the change request database 113. In this manner, the change request database 113 stores schedule information on the approved system changes.

The system change management section 121 provides a terminal device 311 (any of the terminal devices 320a, 320b, 320c, . . . ) operated by the manager with an operation interface that allows the manager to access the system change management section 121. Using the operation interface, the system change management section 121 receives an input of contents of the system change operation, accepts an application from the manager, displays application contents to another manager having the approval authority, and accepts the approval of the application contents from another manager.

The inquiry processing section 122 controls the processing of accepting the inquiry from the user, and the processing of creating the answer to the inquiry. When accepting the inquiry from the user, the inquiry processing section 122 creates the incident ticket that stores inquiry information on the contents of the inquiry. When the respondent creates an answer to the inquiry and requests transmission of the answer to the user, the inquiry processing section 122 transmits the answer information on contents of the answer to the user, and registers the incident ticket including the inquiry information and the answer information in the incident database 112. Accordingly, the incident tickets including previous answer information are stored in the incident database 112.

The inquiry processing section 122 provides a terminal device 321 (any of 320a, 320b, 320c, . . . ) operated by the user with an operation interface that allows the user to access the inquiry processing section 122. Using the operation interface, the user may input contents of the inquiry and transmit the inquiry information. The inquiry processing section 122 provides a terminal device 312 (any of terminal devices 310a, 310b, 310c, . . . ) with an operation interface that allows the respondent to access the inquiry processing section 122. Using the operation interface, the respondent may create the answer to the inquiry.

The FAQ offering section 123 controls the processing of allowing the user and the respondent to refer to the FAQ database 111. For example, the FAQ offering section 123 accepts an input of a search keyword from the user or the respondent, extracts FAQs including the search keyword in inquiries or answers from the FAQ database 111, and presents the FAQs to the user or the respondent. Alternatively, the FAQ offering section 123 may analyze the contents of the accepted inquiry from the user, extracts the FAQs including a proper answer to the inquiry from the FAQ database 111, and present the extracted FAQs to the respondent.

The FAQ offering section 123 provides the terminal device 321 (any of the 320a, 320b, 320c, . . . ) performed by the user with an operation interface that allows the user to access the FAQ offering section 123. Using the operation interface, the user may input a search keyword and view a FAQ search result. When the respondent performs the operation for referring to FAQs during creation of the answer, the FAQ offering section 123 displays a screen for searching the FAQs and a screen for displaying the search result on the terminal device 312 operated by the respondent.

Information on the relationship between the incident tickets in the incident database 112, and the relationship between the incident ticket in the incident database 112 and the change request ticket in the change request database 113 is registered in the relation database 114.

The analysis server 200 has a data storage section 210, a data collection section 221, a data analysis section 222, and a FAQ creation processing section 223. The data storage section 210 stores a collection database (DB) 211.

The data storage section 210 is embodied as a storage area of a storage device of the analysis server 200, such as a RAM 202 and an HDD 203. The processing of the data collection section 221, the data analysis section 222, and the FAQ creation processing section 223 is executed by causing the processor 201 of the analysis server 200 to perform a predetermined application program.

The data collection section 221 collects information used to assist the FAQ creation operation from the operation management server 100. Specifically, the data collection section 221 collects the incident tickets in the incident database 112 and relation data in the relation database 114 periodically (for example, every month), and stores them in the collection database 211. The data collected by the data collection section 221 is stored in the collection database 211.

The data analysis section 222 calculates the level of suitability of each incident ticket registered in the incident database 112 for a fixed nearest period (for example, one year), based on the data stored in the collection database 211. The level of suitability is an indicator that indicates how much the inquiry information and the answer information in the incident ticket is suitable as a candidate for the FAQ registered in the FAQ database 111.

The FAQ creation processing section 223 creates the FAQ according to the operation of the analyzer. At this time, the FAQ creation processing section 223 displays the incident tickets in the order of the calculated level of suitability, and presents the incident tickets suitable for the FAQ registration candidates to the analyzer. Referring to the presented incident tickets, the analyzer may select the incident ticket registered as the FAQ, and appropriately edit the inquiry information and the answer information in the selected incident ticket to create the FAQ. The FAQ creation processing section 223 transmits the created FAQ to the operation management server 100, and registers the FAQ in the FAQ database 111.

The FAQ creation processing section 223 provides a terminal device 313 (any of the terminal devices 310a, 310b, 310c, . . . ) operated by the analyzer with an operation interface that allows the analyzer to access the FAQ creation processing section 223. Using the operation interface, the analyzer may view the FAQ registration candidates extracted from the incident tickets, create the FAQ based on the viewed incident tickets, and request to register the FAQ.

In this embodiment, the data storage section 210, the data collection section 221, the data analysis section 222, and the FAQ creation processing section 223 are provided in the analysis server 200 that is separated from the operation management server 100. However, these sections may be provided in the operation management server 100.

<Processing of Registering Change Request Ticket>

Next, the change request ticket registration processing performed by the operation management server 100 will be described.

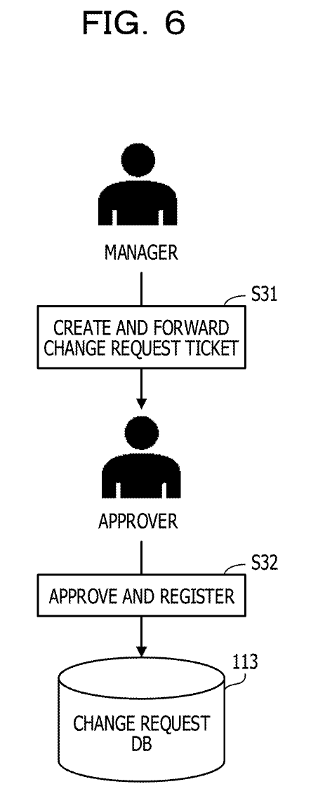

FIG. 6 is a view illustrating the processing of registering the change request ticket. When applying the system change operation, using an application screen displayed on the terminal device 311, the manager inputs contents and schedule of the system change operation, and requests forwarding of them to predetermined one or more other managers having the approval authority (approver). The system change management section 121 creates the change request ticket that stores the inputted contents and schedule of the system change operation, and forwards the created change request ticket to the approver (Step S31).

When the approver approves the change request ticket, the system change management section 121 registers the approved change request ticket in the change request database 113 (Step S32). In this manner, the schedule information on the approved system change is stored in the change request database 113.

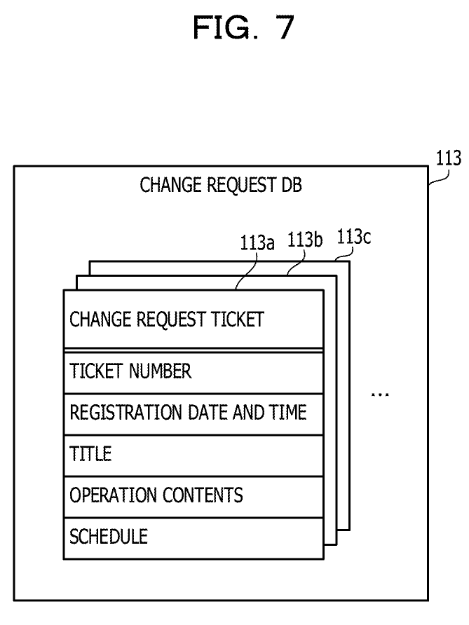

FIG. 7 is a view illustrating an example of data structure in the change request database. Change request tickets 113a, 113b, 113c, . . . are registered in the change request database 113. The change request tickets 113a, 113b, 113c, . . . each have items of ticket number, registration data and time, title, operation contents, and schedule.

The identification number of the change request ticket is registered in the ticket number item. The date and time when the change request ticket is approved and registered in the change request database 113 is registered in the registration data and time item. The title of the system change operation is registered in the title item. The contents of the system change operation are registered in the operation contents item. The scheduled date and time when the system change operation is scheduled to be performed is registered in the schedule item.

<Creation of Answer to Inquiry>

Next, the operation of creating the answer to the inquiry from the user will be described.

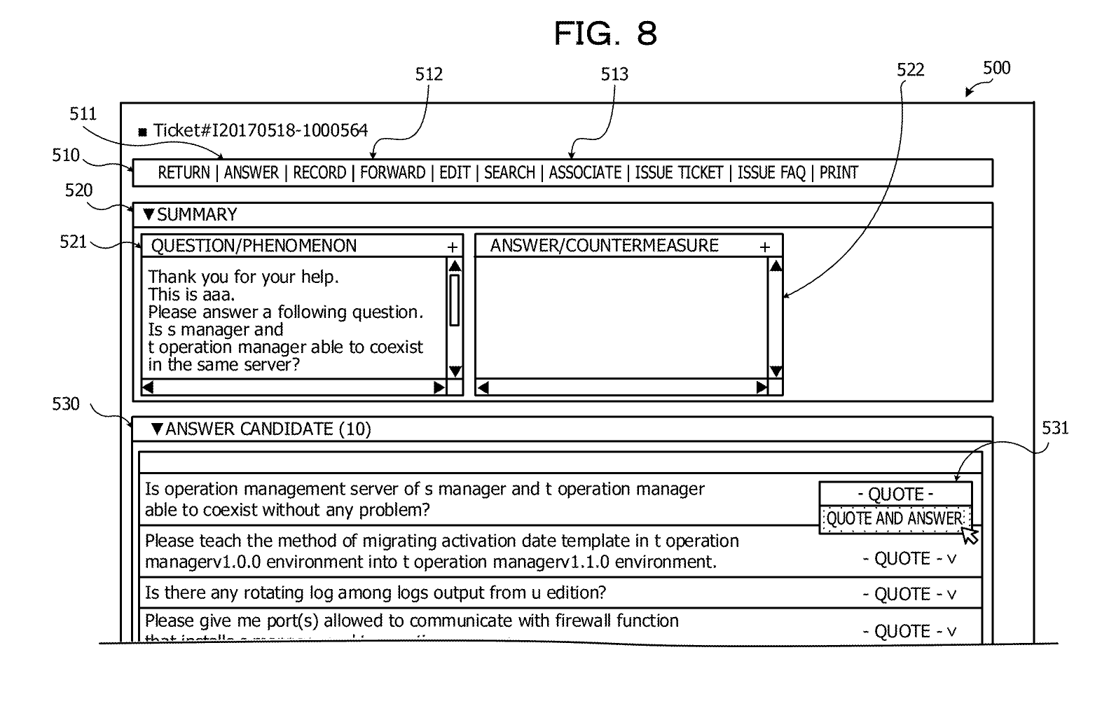

FIG. 8 is a view illustrating an example of an answer creation screen. When accepting the inquiry from the user, the inquiry processing section 122 displays screen display information for creating an answer by the respondent on a terminal device (at least one of the terminal devices 310a, 310b, 310c, . . . ) operated by the respondent. An answer creation screen 500 as illustrated in FIG. 8 is displayed on the terminal device 312 operated by the respondent.

The answer creation screen 500 includes a tool bar 510, and a “summary” display column 520, and an “answer candidate” display column 530 on the incident ticket. Menu items for performing various operations are displayed on the tool bar 510. For example, the menu items such as an “answer” item 511, a “forward” item 512, and ab “association” item 513 are displayed on the tool bar 510. The “summary” display column 520 includes a “question/phenomenon” display column 521 in which contents of the inquiry information are displayed, and an “answer/measure” display column 522 into which contents of the answer information are inputted. Candidates for the answer information to the inquiry information are listed in the “answer candidate” display column 530.

As described above, when accepting the inquiry from the user, the inquiry processing section 122 creates the incident ticket including the inquiry information. When the respondent selects the incident ticket, the inquiry processing section 122 displays the answer creation screen 500, and displays contents of the inquiry information in the incident ticket, in the “question/phenomenon” display column 521.

Further, the inquiry processing section 122 analyzes the contents of the inquiry, and extracts the incident tickets including the answer information suitable for a candidate for the answer information to the contents of the inquiry, from the incident database 112. The inquiry processing section 122 lists the titles of the extracted incident tickets in the “answer candidate” display column 530. The extracted incident tickets are listed as candidates for the answer information in decreasing order of the level of suitability. When the respondent selects the title of any of the listed incident tickets, the contents of the inquiry information and the answer information in the incident ticket are displayed, for example, using a pop-up screen.

The respondent may create the answer information, for example, by inputting characters into the “answer/measure” display column 522. In FIG. 8, it is assumed that the respondent quotes one of the incident tickets listed in the “answer candidate” display column 530, and answers to the inquiry information displayed in the “question/phenomenon” display column 521. In this case, the respondent selects a “quotation” display area 531 set in the title display column of each incident ticket, and selects “quote and answer” for the concerned incident ticket. When the respondent selects “quote and answer”, the inquiry processing section 122 displays the contents of the answer information in the incident ticket, in the “answer/measure” display column 522. The respondent may appropriately edit the contents of the “answer/measure” display column 522.

When the respondent selects the “answer” item 511 of the tool bar 510, the inquiry processing section 122 transmits information displayed in the “answer/measure” display column 522 as the answer information to the inquiry information to the user by using an e-mail or the like. At the same time, the inquiry processing section 122 registers the incident ticket including the inquiry information and the answer information in the incident database 112.

As described above, to the inquiry information from the user, the answer information of the incident ticket listed in the “answer candidate” display column 530 may be quoted. In this case, the inquiry processing section 122 registers relation data indicating the quotation relationship between the incident ticket newly registered in the incident database 112 and another incident ticket quoted at the creation of the answer information, in the relation database 114.

Further, as described later in detail, when an “association” item 513 is selected, the titles of the change request tickets registered in the change request database 113 are listed. The respondent may select the change request ticket including information on the system change operation related to the contents of the inquiry information from the change request tickets, and associate the selected change request ticket with the incident ticket including the inquiry information. At this time, the relation data indicating the association between the selected change request ticket and the incident ticket is registered in the relation database 114.

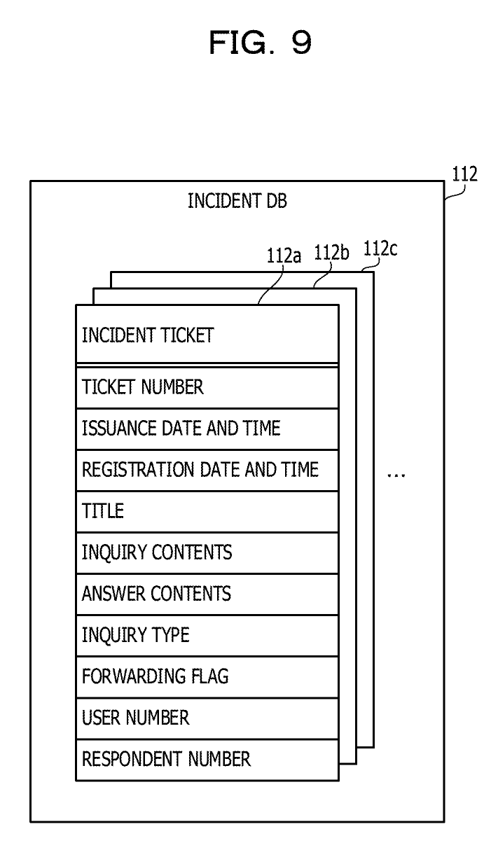

Here, FIG. 9 is a view illustrating an example of a data structure in an incident database. Incident tickets 112a, 112b, 112c, . . . are registered in the incident database 112. The incident tickets 112a, 112b, 112c, . . . each have items including ticket number, issuance date and time, registration data and time, title, inquiry contents, answer contents, inquiry type, forwarding flag, user number, and respondent number.

The identification number of the incident ticket is registered in the ticket number item. The date and time when the inquiry from the user is accepted and the incident ticket is issued (created) is registered in the issuance date and time item. The date and time when the answer information is transmitted to the user and the incident ticket is registered in the incident database 112 is registered in the registration data and time item. The title of the incident ticket is registered in the title item. The contents of the inquiry information are registered in the inquiry contents item. The contents of the answer information are registered in the answer contents item.

Information on the type of the contents of the inquiry information is registered in the inquiry type item. This information indicates the cause for the inquiry. Examples of information registered in the inquiry type item include “system failure”, “program bug”, and “usage misunderstanding”. The “system failure” indicates that the inquiry is made due to the occurrence of a system failure. The “program bug” indicates that the inquiry is made due to a program bug. The “usage misunderstanding” indicates that the inquiry is made due to the user's misunderstanding of the usage.

Flag information on whether or not the incident ticket is forwarded to any manager other than the respondent is registered in the forwarding flag item. In this embodiment, “1” is registered when the incident ticket is forwarded, and “0” is not registered when the incident ticket is forwarded. Forwarding of the incident ticket will be described later in detail. The identification number of the user who makes an inquiry is registered in the user number item. The identification number of the respondent who creates the answer information is registered in the respondent number item.

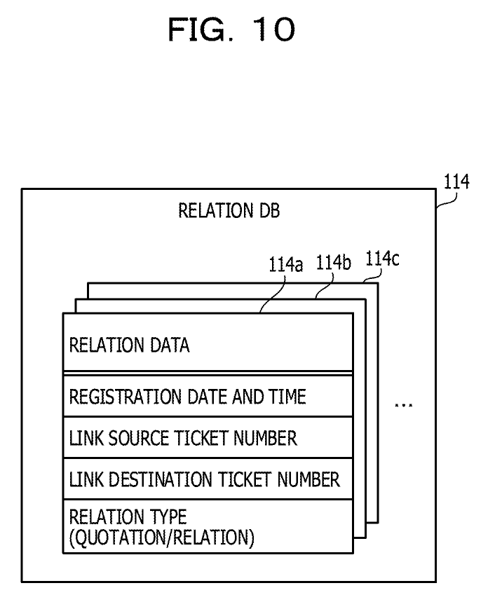

FIG. 10 is a view illustrating an example of a data structure in the relation database. Relation data 114a, 114b, 114c, . . . is registered in the relation database 114. The relation data 114a, 114b, 114c, . . . has items of registration data and time, link source ticket number, link destination ticket number, and relation type.

The date and time when the relation data is registered in the relation database 114 is registered in the registration data and time item. The identification number of the incident ticket of the link source is registered in the link source ticket number item. The identification number of the incident ticket or the change request ticket of the link destination is registered in the link destination ticket number item.

Information on the relation type of the relation data is registered in the relation type item, specifically, “quotation” or “relation”. The “quotation” is registered when the relation data represents the quotation relationship between incident tickets. When the “quotation” is registered, the identification number of the incident ticket is registered in the link destination ticket number item. The “relation” is registered when the relation data represents the relation between the incident ticket and the change request ticket. When the “relation” is registered, the identification number of the change request ticket is registered in the item of link destination ticket number item.

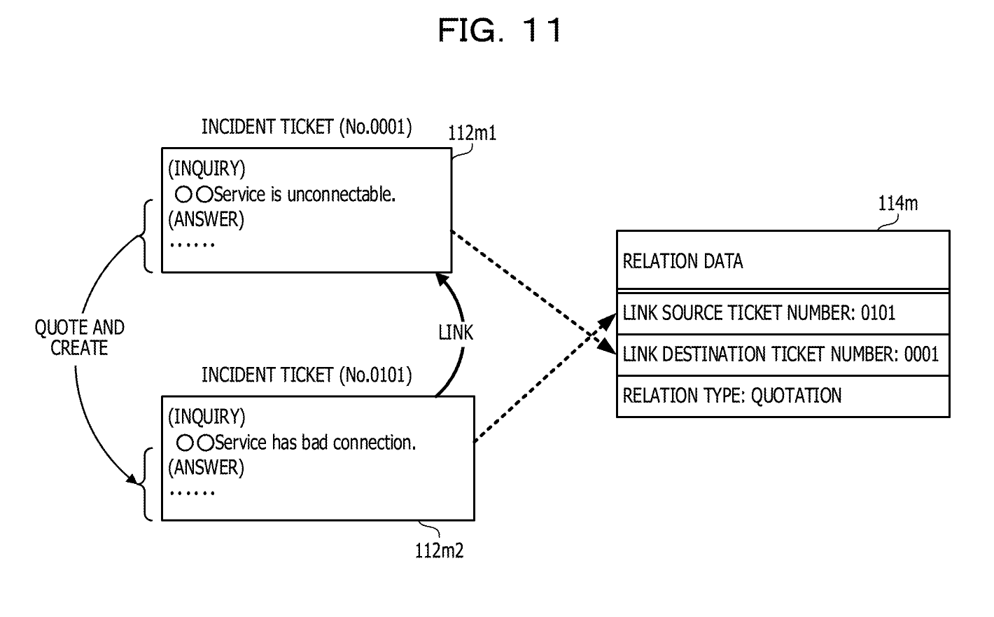

FIG. 11 is a view illustrating an example of the registration of the relation data in the case where the answer information is created by quoting other answer information. In FIG. 11, it is assumed that the answer information in an incident ticket 112m2 is created by quoting at least a portion of the answer information in an incident ticket 112m1 registered in the incident database 112.

In this case, in the relation data 114m, the quotation relationship between the incident ticket 112m1 and the incident ticket 112m2 is represented using the concept of the link from the quotation destination to the quotation source. That is, in the relation data 114m, “0101” representing the incident ticket 112m2 is registered as the link source ticket number, and “0001” representing the incident ticket 112m1 is registered as the link destination ticket number. The “quotation” is registered as the relation type. When transmitting the answer information in the incident ticket 112m2 to the user, the inquiry processing section 122 creates the above-mentioned relation data 114m, and registers the created relation data 114m in the relation database 114.

Next, the operation of associating the change request ticket with the incident ticket will be described. When the “association” item 513 is selected on the answer creation screen 500 illustrated in FIG. 8, the inquiry processing section 122 displays an association screen for associating the change request ticket with the incident ticket on the terminal device 312 performed by the respondent.

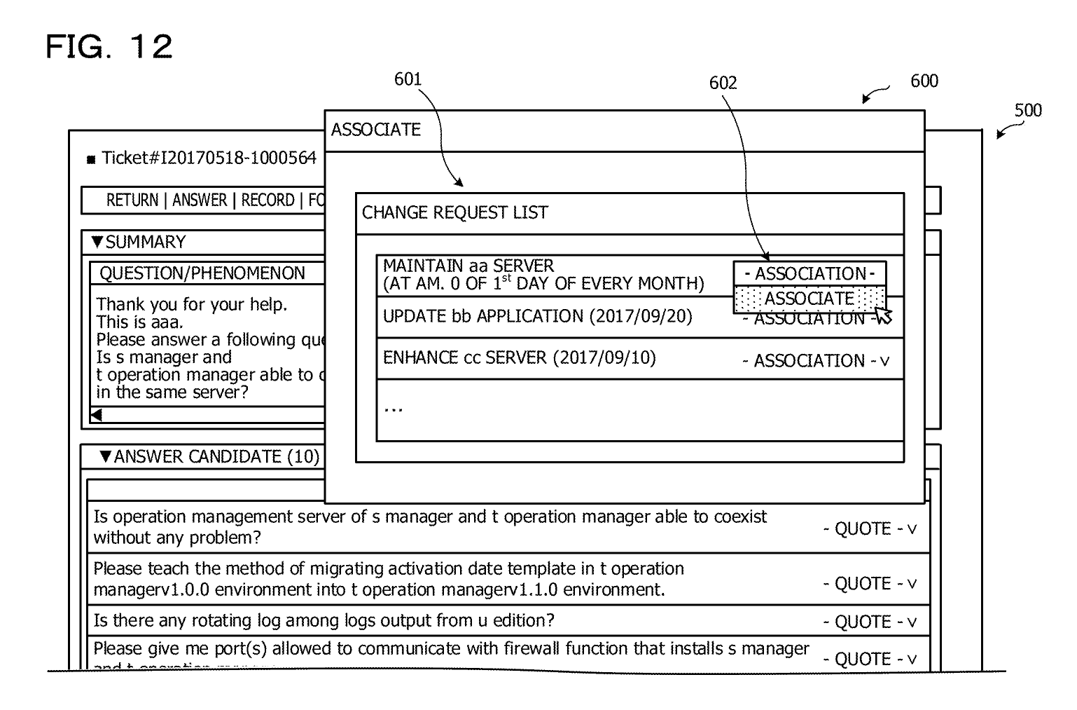

FIG. 12 is a view illustrating a display example of the association screen. FIG. 12 illustrates the case where an association screen 600 is displayed as a window that is different from the answer creation screen 500.

The association screen 600 includes a “change request list” display column 601. A list of titles of the change request tickets registered in the change request database 113 according to the processing of the inquiry processing section 122 is displayed in the “change request list” display column 601. When the respondent selects one title, the contents of the change request ticket (for example, operation contents and schedule) corresponding to the selected title are displayed on, for example, a pop-up screen.

As described above, contents and implementation schedule of the maintenance operation (system change operation) accompanied with any system change are described in the change request ticket. Meanwhile, inquiry information from the user may be related to a particular system change operation. For example, during the system change operation, the processing speed of target equipment such as a server and network equipment may be lowered. This often causes inquires that contribute to degraded performances such as lower display speed and response speed, and troubles such as connection failure.

When contents of the inquiry information transmitted from the user are related to a particular system change operation, the contents and the system change operation may be associated with each other and the association may be recorded, to help the operation of analyzing contents of the inquiry information for improving the quality of services to the user. Thus, the respondent may select the change request ticket that describes the system change operation deemed to be related to contents of the inquiry information, from the change request tickets displayed in the “change request list” display column 601, and associates the selected change request ticket with the inquiry information and record the association.

In performing the associating operation, the respondent selects an “association” display area 602 set in the change request ticket title display column, and further selects “associate” on the concerned change request ticket. In response to this operation, the inquiry processing section 122 associates the incident ticket displayed on the answer creation screen 500 with the change request ticket corresponding to the selected title. Then, when the incident ticket is registered in the incident database 112, the inquiry processing section 122 creates the relation data indicating the association between the incident ticket and the change request ticket, and registers the relation data in the relation database 114.

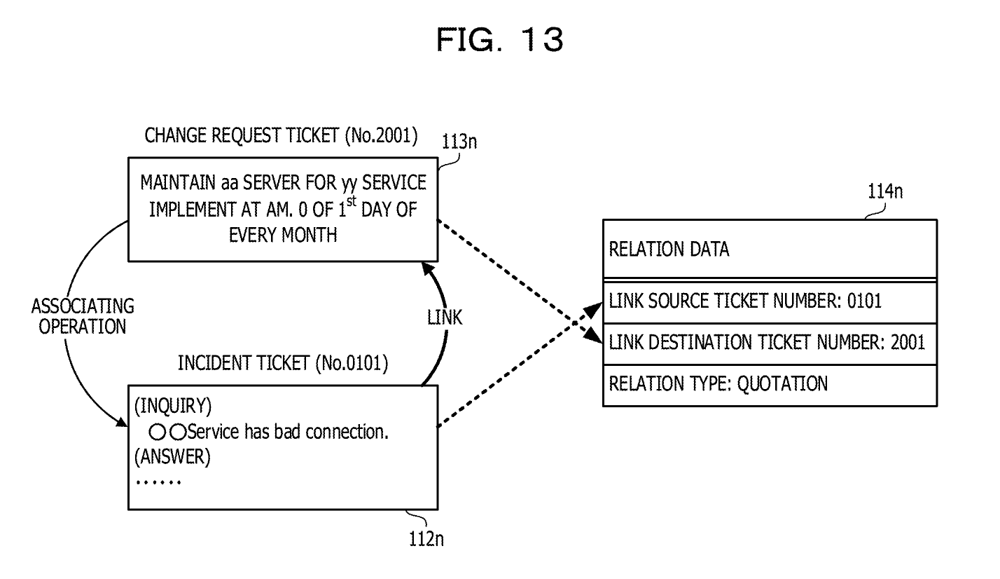

FIG. 13 is a view illustrating an example of the registration of the relation data in the case where the incident ticket is associated with the change request ticket. In FIG. 13, it is determined that contents of the inquiry information in the incident ticket 112n are related to the system change operation described in a change request ticket 113n, and the incident ticket 112n is associated with the change request ticket 113n.

In this case, in relation data 114n, relationship between the incident ticket 112n and the change request ticket 113n is represented using the concept of the link. That is, in the relation data 114n, “0101” representing the incident ticket 112n is registered as the link source ticket number, and “2001” representing the change request ticket 113n is registered as the link destination ticket number. Also, “association” is registered as the relation type. When transmitting the answer information in the incident ticket 112n to the user, the inquiry processing section 122 creates the above-mentioned relation data 114n, and registers the created relation data 114n in the relation database 114.

Next, forwarding of the inquiry information will be described. When the respondent may not create answer information to accepted inquiry information by oneself, the respondent may forward the inquiry information to another manager having more sophisticated professional knowledge. Examples of the manager to be forwarded include a high-ranking respondent associated with the respondent, and a person in charge of maintenance or development of the information processing system 400. The respondent may use information received from the manager to be forwarded to create the answer information.

When forwarding another manager to the inquiry information, the respondent selects the “forward” item 512 on the answer creation screen 500 illustrated in FIG. 8. According to the selection, the inquiry processing section 122 displays the forwarding screen for forwarding the inquiry information on the terminal device 312 performed by the respondent.

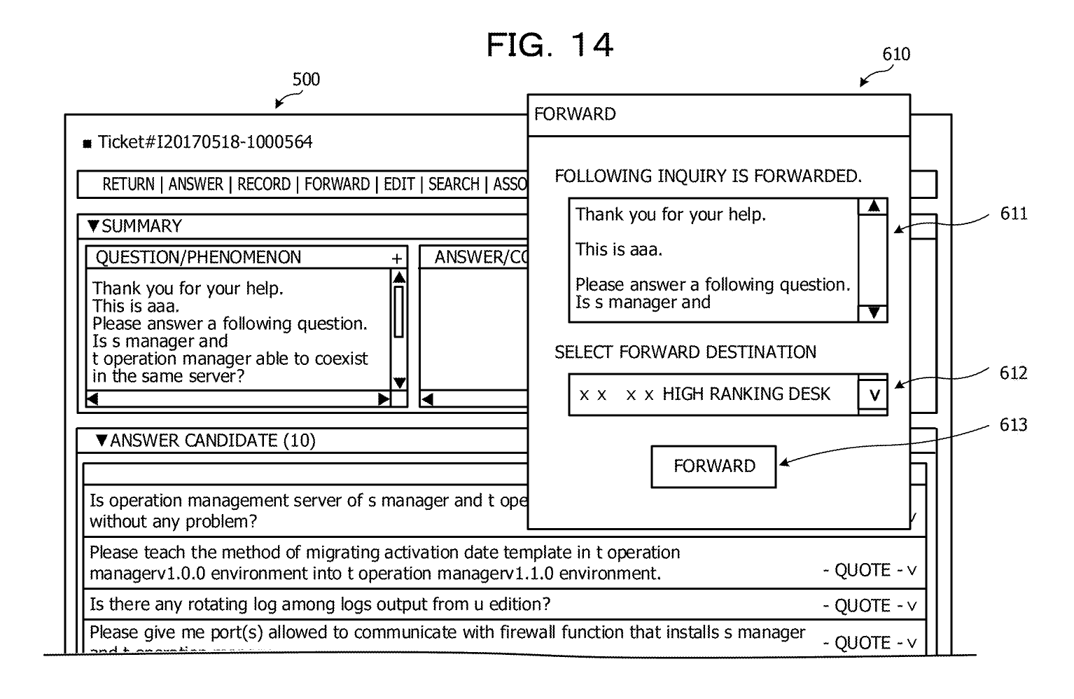

FIG. 14 is a view illustrating an example of a forwarding screen. FIG. 14 illustrates the case where the forwarding screen 610 is displayed as a screen that is different from the answer creation screen 500.

The forwarding screen 610 includes a display column 611 for displaying the inquiry information, a selection section 612 for selecting the manager to be forwarded, and an instruction button 613 for instructing forwarding. The respondent operates the selection section 612 to select the manager to be forwarded, and selects the instruction button 613. According to the operation, the inquiry processing section 122 transmits transmission information to instruct the selected manager to be forwarded to view contents of the incident ticket including the inquiry information and contact the respondent, to the manager, by using an e-mail or the like.

The respondent creates answer information to the inquiry information, and at transmission of the answer information to the user, records the forwarding of the inquiry information. When the incident ticket including the inquiry information and the answer information is recorded in the incident database 112, the inquiry processing section 122 sets “1” to the forwarding flag of the incident ticket to record that the inquiry information is forwarded. Alternatively, the inquiry processing section 122 may record that forwarding is instructed via the forwarding screen 610, and based on the record, automatically set “1” to the forwarding flag of the incident ticket at recording of the incident ticket.

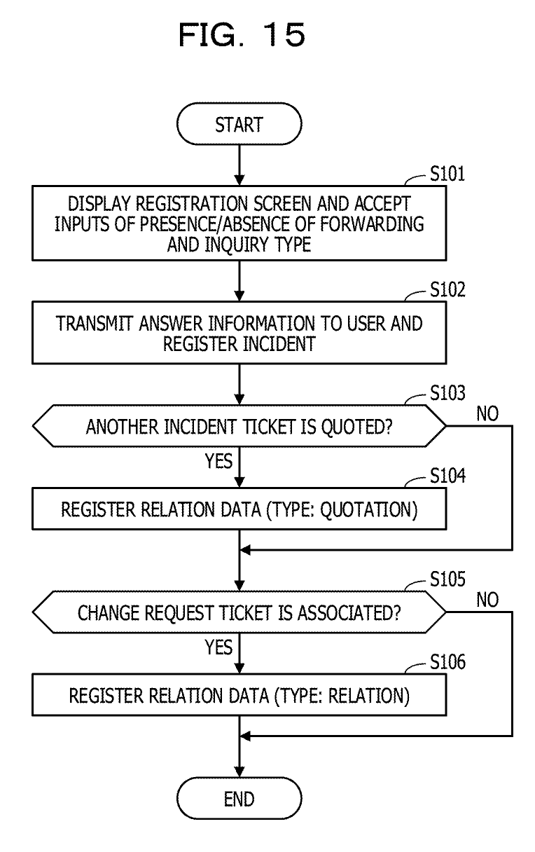

FIG. 15 is a flow chart illustrating an example of the processing of registering the incident ticket. When finishing inputting of the answer information into the “answer/measure” display column 522 on the answer creation screen 500, the respondent selects the “answer” item 511 to transmit the answer information. The inquiry processing section 122 executes following processing according to the selection.

[Step S101] The inquiry processing section 122 displays a registration screen for accepting inputs of various information in the incident ticket on the terminal device 312 operated by the respondent. The registration screen includes an input area for inputting the presence/absence of forwarding of the inquiry information to another manager, and the inquiry type. When accepting the inputs, the inquiry processing section 122 executes the processing in Step S102.

[Step S102] The inquiry processing section 122 transmits the answer information to the user by using an e-mail or the like. At the same time, the inquiry processing section 122 registers the incident ticket including the inquiry information and the answer information in the incident database 112. At this time, information corresponding to the contents inputted in Step S101 is registered in the items of forwarding flag and inquiry type of the incident ticket.

[Step S103] The inquiry processing section 122 determines whether or not the answer information in another incident ticket is quoted at the creation of the answer information. The inquiry processing section 122 executes the processing in Step S104 when the answer information of another incident ticket is quoted, and executes the processing in Step S105 when the answer information of another incident ticket is not quoted.

[Step S104] The inquiry processing section 122 creates the relation data in the “quotation” is set as the relation type. On the created relation data, the inquiry processing section 122 sets the identification number of the incident ticket registered in Step S102 as the link source ticket number, and the identification number of another incident ticket quoted at the creation of the answer information as the link destination ticket number. The inquiry processing section 122 registers the relation data thus created in the relation database 114.

[Step S105] The inquiry processing section 122 determines whether or not the operation of associating with the change request ticket is performed at the creation of the answer information. The inquiry processing section 122 executes the processing in Step S106 when the associating operation is performed, and terminates the processing when the associating operation is not performed.

[Step S106] The inquiry processing section 122 creates the relation data that sets “association” as relation type. On the created relation data, the inquiry processing section 122 sets the identification number of the incident ticket registered in Step S102 as the link source ticket number, and sets the identification number of the associated change request ticket as the link destination ticket number. The inquiry processing section 122 registers the relation data thus created in the relation database 114.

<Assistance of FAQ Creation Operation>

Next, the processing of assisting the FAQ creation operation of the analysis server 200 will be described.

The analysis server 200 extracts FAQ registration candidates from the incident tickets registered in the incident database 112 for a predetermined nearest period (for example, one year), and presents the candidates to the analyzer. The FAQ registration candidate denotes the incident ticket including the inquiry information and the answer information, which is estimated to be suitable for the FAQ to be registered in the FAQ database 111. In this embodiment, the level of suitability for the FAQ registration candidate is calculated for each incident ticket, and the incident tickets are presented in decreasing order of the level of suitability.

In the analysis server 200, the data collection section 221 periodically collects information stored in the incident database 112 and the relation database 114, as information used to calculate the level of suitability, from the operation management server 100. In this embodiment, the data collection section 221 collects the information every month.

Here, at the information collection timing, the data collection section 221 may collect the information registered in the incident database 112 and the relation database 114 for the nearest one month. However, it is more desirable to collect the information according to a following way.

At the information collection timing, the data collection section 221 collects the incident tickets issued for the nearest one month from the incident tickets registered in the incident database 112. The incident ticket issuance date and time represents the date and time when the inquiry information is accepted, and is registered in the incident ticket issuance date and time item. By collecting the incident tickets issued for the nearest one month, as described later, the relation between the collected incident ticket and the implementation timing of the system change operation based on the change request ticket may be correctly determined. The data collection section 221 collects the relation data in which the identification number indicating any of the incident tickets collected according to the above-mentioned method is registered as the link source ticket number, from the relation data registered in the relation database 114.

The data collection section 221 registers the incident ticket and the relation data thus collected in the collection database 211. When the collection database 211 is updated, the data analysis section 222 identifies incident tickets and the relation data registered (that is, collected) in the collection database 211 for a predetermined nearest period, and based on the identified information, calculates the level of suitability of each of the identified incident tickets. Since the predetermined period is preferably long to some extent, in this embodiment, the incident tickets and relation data collected for the nearest one year are identified.

Using a plurality of below-mentioned determination standards, the data collection section 221 calculates the level of suitability of each incident ticket. The determination standards include a “point-addition determination standard” estimated to be suitable for the FAQ registration candidate when the determination standard is satisfied, and a “point-deduction determination standard” estimated to be unsuitable for the FAQ registration candidate when the determination standard is satisfied. Specifically, the below-mentioned point-addition determination standards A1 to A6 and point-deduction determination standards B1, B2 are used.

(Point-addition determination standard A1: Quoted number is high) Quoted number denotes the number of times that the answer information included in the incident ticket to be determined is quoted at the creation of the answer information of another incident ticket. A high quoted number represents that there is a lot of pieces of inquiry information, contents of which are similar to the inquiry information in the incident ticket to be determined. In such case, it is determined that the incident ticket to be determined is desirably shared as the FAQ among many users and respondents.

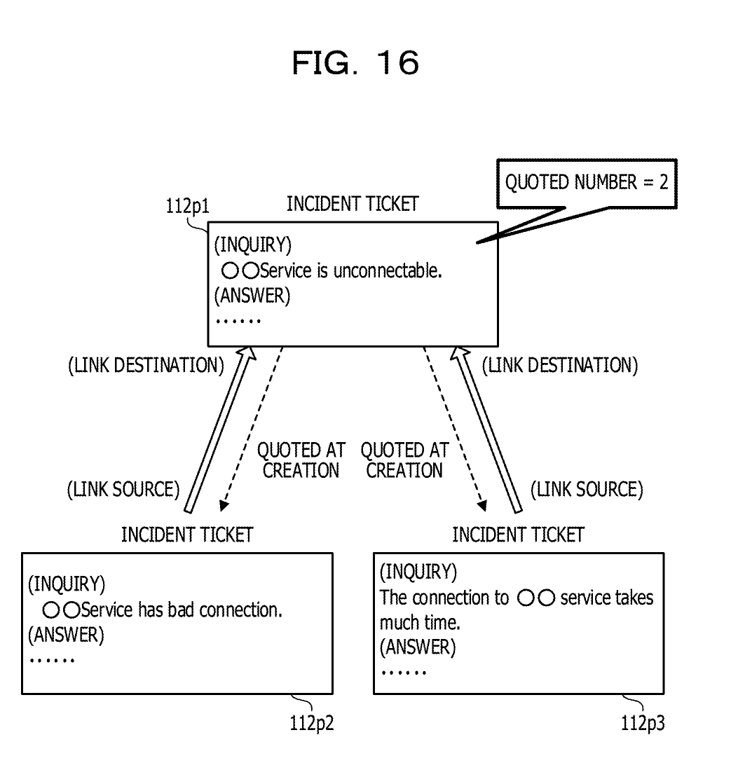

FIG. 16 is a view of an example of the processing of calculating the quoted number. As described above, the quotation relationship between the incident tickets is recorded in relation data having the relation type “quotation”. Accordingly, the data analysis section 222 may calculate the quoted number for each incident ticket, based on the relation data having the relation type “quotation”, which is collected by the data collection section 221.

FIG. 16 illustrates the case where the answer information in an incident ticket 112p1 is quoted at the creation of answer information in two incident tickets 112p2, 112p3. In this case, following two pieces of relation data are collected. In one relation data, the identification number of the incident ticket 112p2 is registered as the link source ticket number, and the identification number of the incident ticket 112p1 is registered as the link destination ticket number. In the other relation data, the identification number of the incident ticket 112p3 is registered as the link source ticket number, and the identification number of the incident ticket 112p1 is registered as the link destination ticket number. Based on the relation data, the data analysis section 222 calculates the quoted number of the incident ticket 112p1 as “2”.

(Point-addition determination standard A2: Inquiry type is “usage misunderstanding”) As described above, the inquiry type indicating the cause for an inquiry is registered in the incident ticket. One of the inquiry types is “usage misunderstanding” indicating that the user makes an inquiry due to usage misunderstanding. When the inquiry type of the incident ticket to be determined is “usage misunderstanding”, contents of the inquiry information in the incident ticket may be understood by the user if correct usage is explained to the user. Thus, the incident ticket is determined to be published to the user as the FAQ.

(Point-addition determination standard A3: Inquiry information is forwarded to another manager) At the response to the inquiry information by the respondent, when the inquiry information is forwarded to another manager, man-hour requested for creating the answer information increases. The man-hour requested for creating the answer may be decreased by preparing the inquiry information and the created answer information as FAQs, and allowing the respondent to view the FAQs. By publishing the inquiry information and the answer information as the FAQs to the user, useful information may be also given to the user to decrease the number of inquiries from users as well as personnel and physical resources on the side of the respondent.

(Point-addition determination standard A4: A lot of incident tickets are issued at a particular system change operation) During a certain system change operation, a lot of inquiries related to the system change operation tend to occur. For example, during the system change operation, the processing speed of equipment to be operated, such as a server and a network device, may be lowered. For this reason, inquiries tend to occur due to deteriorated performances such as low display speed and response speed, and troubles such as failure to keep connection.

Thus, when the inquiry contents of a lot of incident tickets are related to a particular system change operation, the data analysis section 222 determines that it is desirable to share the contents of the incident ticket among a lot of users or respondents as FAQs. The relation between the system change operation and the incident ticket may be determined based on relation data having the relation type of “relation”. Accordingly, based on the relation data, the data analysis section 222 identifies the incident tickets associated with a certain change request ticket. When the number of the identified incident tickets is equal to or greater than a predetermined number, the data analysis section 222 determines that each of the incident tickets satisfies the point-addition determination standard A4.

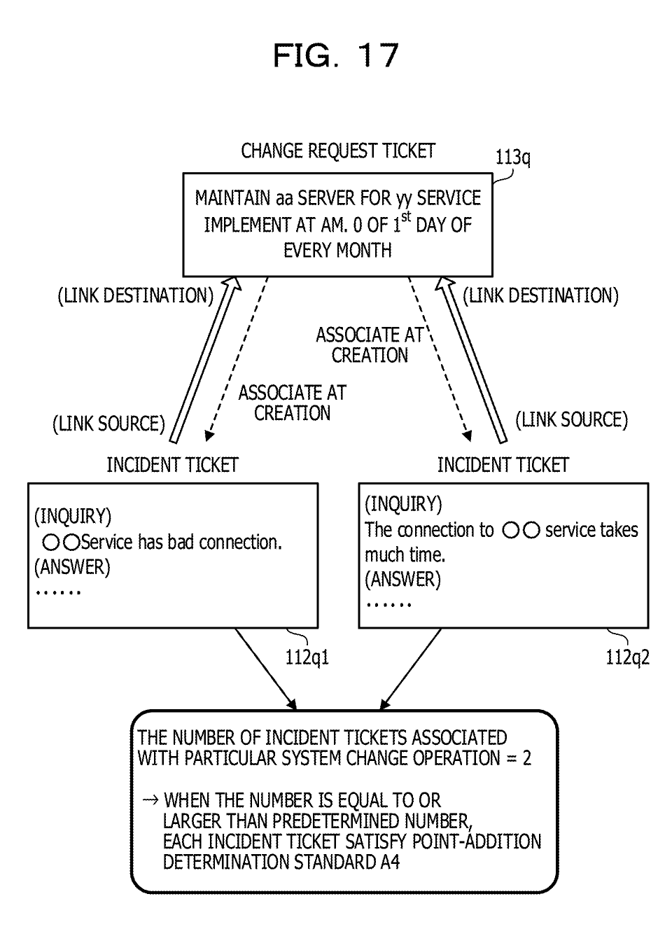

FIG. 17 is a view illustrating an example of the processing of counting the number of incident tickets related to a particular system change operation. In FIG. 17, two incident tickets 112q1, 112q2 are associated with a same change request ticket 113q. In this case, for each of the incident tickets 112q1, 112q2, the number of the incident tickets associated with the particular system change operation is calculated as “2”. When the number of the incident tickets is equal to or greater than a predetermined number, it is determined that each of the incident tickets 112q1, 112q2 satisfies the point-addition determination standard A4.

In this embodiment, the respondent associates the incident ticket with the change request ticket. However, such association may be made by the processing of the analysis server 200 without any manual operation. For example, the data analysis section 222 executes following processing using the incident database 112 and the change request database 113.

The data analysis section 222 identifies incident tickets that are issued from the user within a fixed period from a scheduled time of the system change operation and has the inquiry type of “system failure”, as incident tickets including contents related to the system change operation. When the number of the identified incident tickets is equal to or greater than a predetermined number, the data analysis section 222 determines that each of the incident tickets satisfies the point-addition determination standard A4.

In this embodiment, it is determined whether or not the point-addition determination standard A4 is satisfied based on the association between the system change operation and the incident ticket. However, irrespective of presence/absence of a configuration change of the information processing system 400, it may be determined whether or not the point-addition determination standard A4 is satisfied based on the association between the maintenance operation that temporarily stops the operation of the information processing system 400 or temporarily degrades performances of the operation of the information processing system 400, and the incident ticket.

(Point-addition determination standard A5: Quoted respondent is biased) A particular respondent may quote answer information in the incident ticket to be determined, at the creation of an answer, many times. In this case, the incident ticket may be prepared as the FAQ to be viewed by the respondent, thereby bringing efficiency to the respondent's response operation. In the above-mentioned case, since a lot of similar inquiries in a certain field may occur, the incident ticket may be prepared as the FAQ to generalize and publish knowledge in the certain field, which is shared among only limited respondents.

(Point-addition determination standard A6: Diversion ratio when quoted is high) When the answer information in the incident ticket to be determined is quoted at the creation of other answer information, as the ratio at which contents of the original answer information are diverted to other answer information is higher, the possibility that the contents of the inquiry information corresponding to each answer information becomes higher. In such case, inquiry information having similar contents is transmitted multiple times. For this reason, the incident ticket having a high diversion ratio when quoted by other answer information is determined to be desirably shared as the FAQ among a lot of users and respondents.

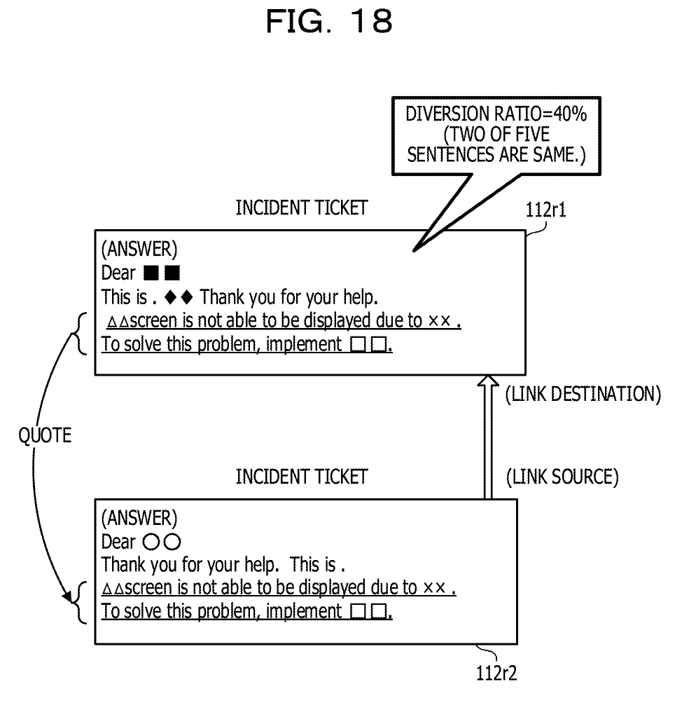

FIG. 18 is a view illustrating an example of the processing of calculating the diversion ratio. In FIG. 18, answer information in an incident ticket 112r1 is partially quoted at the creation of answer information in an incident ticket 112r2. Here, the answer information in the incident ticket 112r1 on the quotation source includes five sentences, and the two sentences among them match sentences in the answer information in the incident ticket 112r2 on the quotation destination. In this case, the diversion ratio is calculated as 40%.

In the above example, the diversion ratio is calculated based on whether or not the sentence on the quotation source matches the sentence on the quotation destination. However, the diversion ratio may be calculated based on whether or not the sentence on the quotation source is similar to the sentence on the quotation destination. For example, when it is determined that two of five sentences included on the quotation source are similar to the two sentences on the quotation destination, the diversion ratio is determined as 40%.

(Point-deduction determination standard B1: The number of recent quoted number is small) As described above, when the point-addition determination standard A1 that the quoted number is large is satisfied, it is deemed that the incident ticket to be determined is suitable for the candidate for FAQ. However, even if the quoted number is large for a long term such as one year, the quoted number may gradually decrease and become small for a nearest one month. For example, for the incident ticket including inquiry information on the previously solved problem, the quoted number may gradually decrease. Therefore, it is determined that such incident ticket will not be referred in future so much, and is not suitable for the FAQ registration candidate.

(Point-deduction determination standard B2: The user making an inquiry is biased) It is assumed that answer information in the incident ticket to be determined is quoted by a plurality of pieces of other answer information. In this case, inquiry information corresponding to the other answer information on the quotation destination may be transmitted from a particular user. In such case, the inquiry information having similar contents is transmitted from the particular user many times. In such case, the contents of the inquiry information are likely to be related to a usage unique to the inquiring user, and are less likely to be inquired by other users. Accordingly, in such case, the incident ticket to be determined is not important for a lot of users, and is determined as being unsuitable for the FAQ registration candidate.

As described above, using a lot of determination standards, the analysis server 200 calculates the level of suitability for the FAQ registration candidate in each incident ticket. By using the lot of determination standards, the suitability for the incident ticket as the FAQ registration candidate may be evaluated in a many-sided way. As a result, the accuracy of calculating the level of suitability may be improved. Accordingly, the analyzer may select the incident ticket according to the level of suitability and create the FAQ based on the incident ticket, to create the FAQ useful for both of users and respondents. The working efficiency of the analyzer may be increased while improving the quality of the created FAQ.

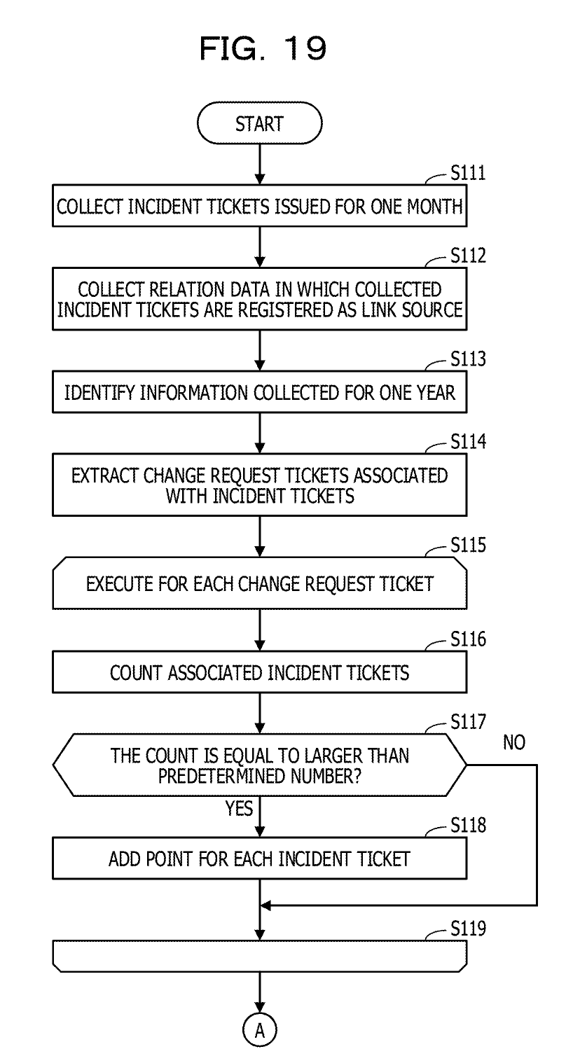

Next, the processing of the analysis server 200 will be described using flow charts. In FIGS. 19 to 22, the level of suitability for each incident ticket as the FAQ registration candidate is quantified in terms of points, for example, by adding 1 when one point-addition determination standard is satisfied and deducting 1 when one point-deduction determination standard is satisfied. A weight may be appropriately assigned to the point added or deducted when the determination standard is satisfied. For example, a weighting factor is set for each determination standard according to contents of the information processing services of targets to be operated and managed.

FIGS. 19 to 22 are flow charts illustrating examples of the processing of the analysis server. The processing in FIGS. 19 to 22 is executed at the information collection timing every month.

[Step S111] The data collection section 221 collects the incident tickets issued for the nearest one month from the incident database 112 of the operation management server 100. The data collection section 221 registers the collected incident tickets in the collection database 211.

[Step S112] The data collection section 221 collects relation data, in which the identification numbers of the incident tickets collected as the link source ticket number in Step S111 are registered, from the relation database 114 of the operation management server 100. The data collection section 221 registers the collected relation data in the collection database 211.

[Step S113] The data analysis section 222 identifies incident tickets and relation data collected for one nearest year from the collection database 211. In the processing in next Step S114 and following steps, the information identified in Step S113 is to be processed. Hereinafter, the identified incident ticket and relation data are referred to as “incident tickets collected for one year” and “relation data collected for one year”, respectively.

[Step S114] The data analysis section 222 identifies relation data having the relation type of “relation” from the relation data collected for one year. The data analysis section 222 extracts the change request tickets associated with the incident tickets in the identified relation data. Specifically, the data analysis section 222 refers to the link destination ticket number item in each of the identified relation data, and extracts identification numbers of all of the change request tickets registered in the items.

[Step S115] The data analysis section 222 executes processing up to the loop end in Step S119 for each of the change request tickets extracted in Step S114.

[Step S116] The data analysis section 222 refers to the relation data having the relation type of “relation”, which is identified in Step S114, and identifies the incident tickets associated with the change request tickets to be processed. The data analysis section 222 counts the number of the identified incident tickets.

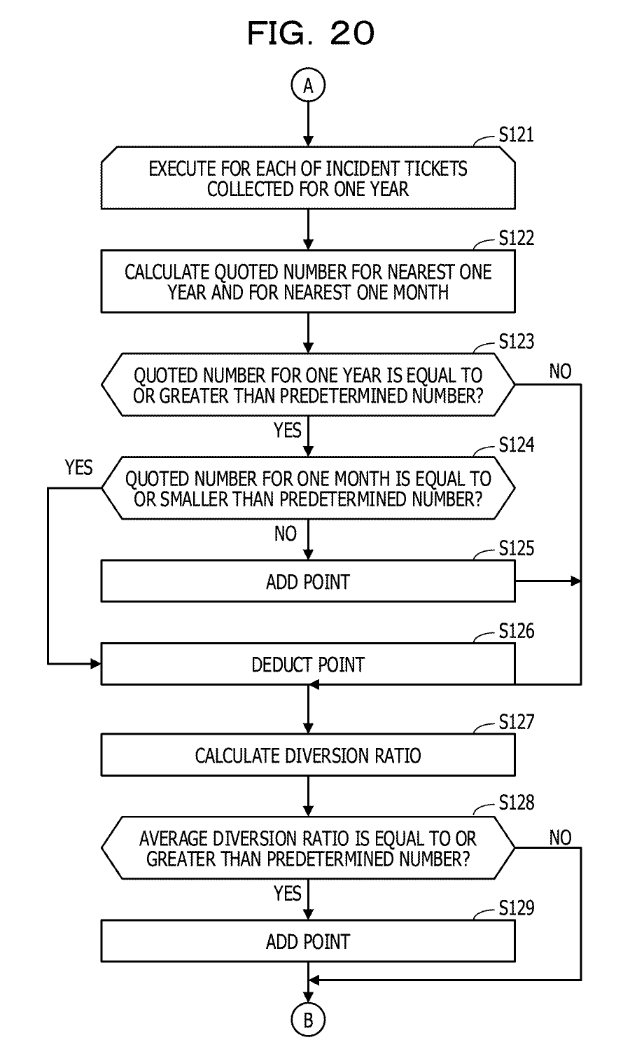

Specifically, the data analysis section 222 identifies, from the above-mentioned relation data, the relation data in which the identification number of the change request ticket to be processed is registered as the link destination ticket number. The number of the identified relation data is a count of the incident tickets.

[Step S117] The data analysis section 222 determines whether or not the number of the incident tickets counted in Step S116 is equal to or greater than a predetermined number. The data analysis section 222 executes the processing in Step S118 when the number of the incident tickets is equal to or greater than the predetermined number, and proceeds the procedure to Step S119 when the number of the incident tickets is smaller than the predetermined number.

[Step S118] The incident tickets identified in Step S116 are associated with the change request tickets indicating a particular system change operation. Since the number of the incident tickets is equal to or greater than the predetermined number, all of the identified incident tickets satisfy the point-addition determination standard A4. Accordingly, the data analysis section 222 adds “1” to the point indicating the level of suitability of each incident ticket. Initially, the point of each incident ticket is set to “0”.

[Step S119] When the processing in Step S116 to S118 is executed for each of the change request tickets extracted in Step S114, the data analysis section 222 executes the processing in Step S121 in FIG. 20.

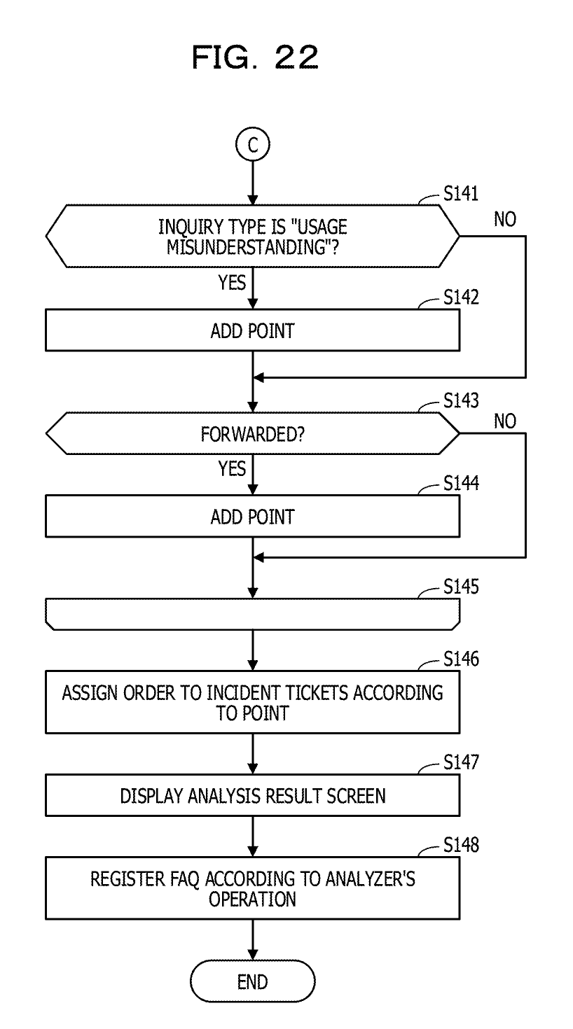

The following description is made with reference to FIG. 20.

[Step S121] The data analysis section 222 executes processing up to the loop end in Step S145 in FIG. 22, for each of incident tickets collected for one year.

[Step S122] The data analysis section 222 calculates the quoted number (the number of quotations at the creation of answer information in other incident tickets) of the incident tickets to be processed for the nearest one year. Further, the data analysis section 222 calculates the quoted number of the incident tickets to be processed for the nearer one month.

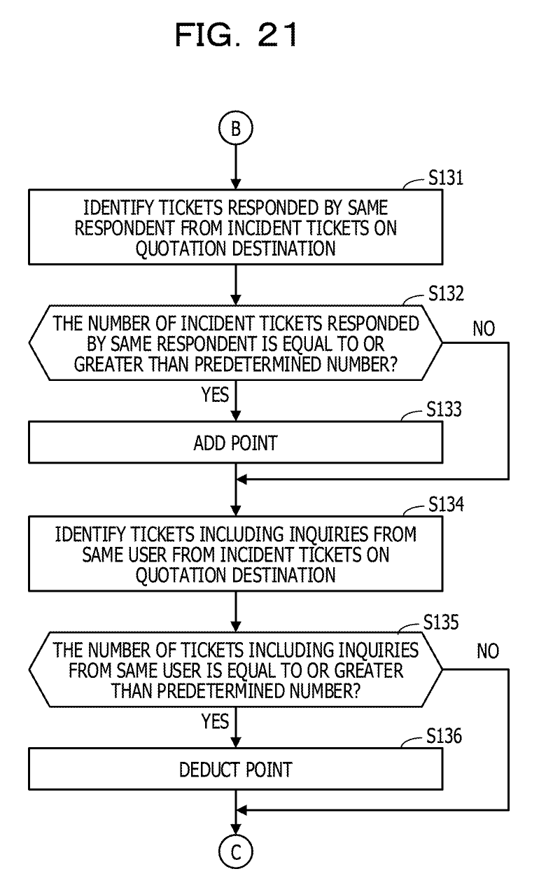

Specifically, the data analysis section 222 identifies relation data in which the relation type is “quotation” and the identification numbers of the incident tickets to be processed are recorded as the link source ticket number, from relation data collected for one year. The number of the identified relation data becomes the quoted number for one year. The data analysis section 222 calculates the quoted number for the nearest one month based on the identified relation data.

[Step S123] The data analysis section 222 determines whether or not the quoted number for the nearest one year is equal to or greater than a predetermined threshold value Th1. The data analysis section 222 executes the processing in Step S124 when the quoted number is equal to or greater than the threshold value Th1, and executes the processing in Step S127 when the quoted number is smaller than the threshold value Th1.

[Step S124] The data analysis section 222 determines whether or not the quoted number for the nearest one month is equal to or smaller than a predetermined threshold value Th2 (wherein, Th2<Th1/12). The data analysis section 222 executes the processing in Step S126 when the quoted number is equal to or smaller than the threshold value Th2, and executes the processing in Step S125 when the quoted number is larger than the threshold value Th2.

[Step S125] In this case, the incident ticket to be processed satisfied the point-addition determination standard A1, and does not satisfy the point-deduction determination standard B1. Accordingly, the data analysis section 222 adds “1” to the point of the incident ticket to be processed.

[Step S126] In this case, the incident ticket to be processed satisfies the point-deduction determination standard B1. Accordingly, the data analysis section 222 deducts “1” from the point of the incident ticket to be processed.

[Step S127] The data analysis section 222 calculates the diversion ratio at quotation for each of other incident tickets that quote the incident ticket to be processed, based on the relation data identified in Step S122.

[Step S128] The data analysis section 222 determines whether or not an average value of the diversion ratio calculated in Step S127 (average diversion ratio) is equal to or greater than a predetermined value. The data analysis section 222 executes the processing in Step S129 when the average diversion ratio is equal to or greater than the predetermined value, and executes the processing in Step S131 in FIG. 21 when the average diversion ratio is smaller than the predetermined value.

[Step S129] In this case, the incident ticket to be processed satisfies the point-addition determination standard A6. Accordingly, the data analysis section 222 adds “1” to the point of the incident ticket to be processed.

The following description is made with reference to FIG. 21.

[Step S131] Based on the relation data identified in Step S122, the data analysis section 222 identifies other incident tickets (incident tickets on the quotation destination) that quote the incident ticket to be processed. The data analysis section 222 identifies the incident tickets responded by the same respondent from the incident tickets on the quotation destination.

[Step S132] The data analysis section 222 determines whether or not the number of incident tickets responded by the same respondent is equal to or greater than a predetermined value. The data analysis section 222 executes the processing in Step S133 when the number of the concerned incident tickets is equal to or greater than the predetermined value, and executes the processing in Step S134 when the number of the concerned incident tickets is smaller than the predetermined value.

[Step S133] In this case, the incident ticket to be processed satisfies the point-addition determination standard A5. Accordingly, the data analysis section 222 adds “1” to the point of the incident ticket to be processed.

[Step S134] The data analysis section 222 identifies the incident tickets including the inquiry information from the same user, from the incident tickets on the quotation destination identified in Step S131.

[Step S135] The data analysis section 222 determines whether or not the number of the incident tickets including the inquiry information from the same user is equal to or greater than a predetermined number. The data analysis section 222 executes the processing in Step S136 when the number of such incident tickets is equal to or greater than the predetermined number, and executes the processing in Step S141 in FIG. 22 when the number of such incident tickets is smaller than the predetermined number.

[Step S136] In this case, the incident ticket to be processed satisfies the point-deduction determination standard B2. Accordingly, the data analysis section 222 deducts “1” from the point of the incident ticket to be processed.

The following description is made with reference to FIG. 22.

[Step S141] The data analysis section 222 determines whether or not the inquiry type of the incident ticket to be processed is “usage misunderstanding”. The data analysis section 222 executes the processing in Step S142 when the inquiry type is “usage misunderstanding”, and executes the processing in Step S143 when the inquiry type is not “usage misunderstanding”.

[Step S142] In this case, the incident ticket to be processed satisfies the point-addition determination standard A2. Accordingly, the data analysis section 222 adds “1” to the point of the incident ticket to be processed.

[Step S143] The data analysis section 222 determines whether or not the incident ticket to be processed is forwarded to another manager based on the forwarding flag of the incident ticket. When the data analysis section 222 executes the processing in Step S144 when the incident ticket is forwarded to another manager, and executes the processing in Step S145 when the incident ticket is not forwarded to another manager.

[Step S144] The incident ticket to be processed satisfies the point-addition determination standard A3. Accordingly, the data analysis section 222 adds “1” to the point of the incident ticket to be processed.

[Step S145] When the processing in Step S122 in FIG. 20 to Step S144 in FIG. 22 is executed for each of the incident tickets to be processed, the data analysis section 222 executes the processing in Step S146.

Through the above-mentioned processing, the point indicating the level of suitability for each of the incident tickets collected for one year is established.

[Step S146] The FAQ creation processing section 223 assigns the order to the incident tickets in the decreasing order of established point.

[Step S147] The FAQ creation processing section 223 displays an analysis result screen presenting the analysis result of the incident ticket on a terminal device 313 operated by the analyzer. For example, the titles of a predetermined number of incident tickets are displayed on the analysis result screen, as the FAQ registration candidates, in the decreasing order assigned in Step S147.

[Step S148] The FAQ creation processing section 223 creates the FAQ according to the operation of the analyzer, and registers the created FAQ in the FAQ database 111 of the operation management server 100. For example, when receiving the selection of one of the incident tickets displayed on the analysis result screen, the FAQ creation processing section 223 displays the inquiry information and the answer information in the selected incident ticket on the terminal device 313. The FAQ creation processing section 223 receives an instruction to register the displayed inquiry information and answer information, and information partially edited by the analyzer, as FAQ. Then, the FAQ creation processing section 223 transmits the information to be registered as the FAQ to the operation management server 100, and instructs to register the FAQ in the FAQ database 111.

Next, an example of the analysis result screen displayed in Step S147 will be described.

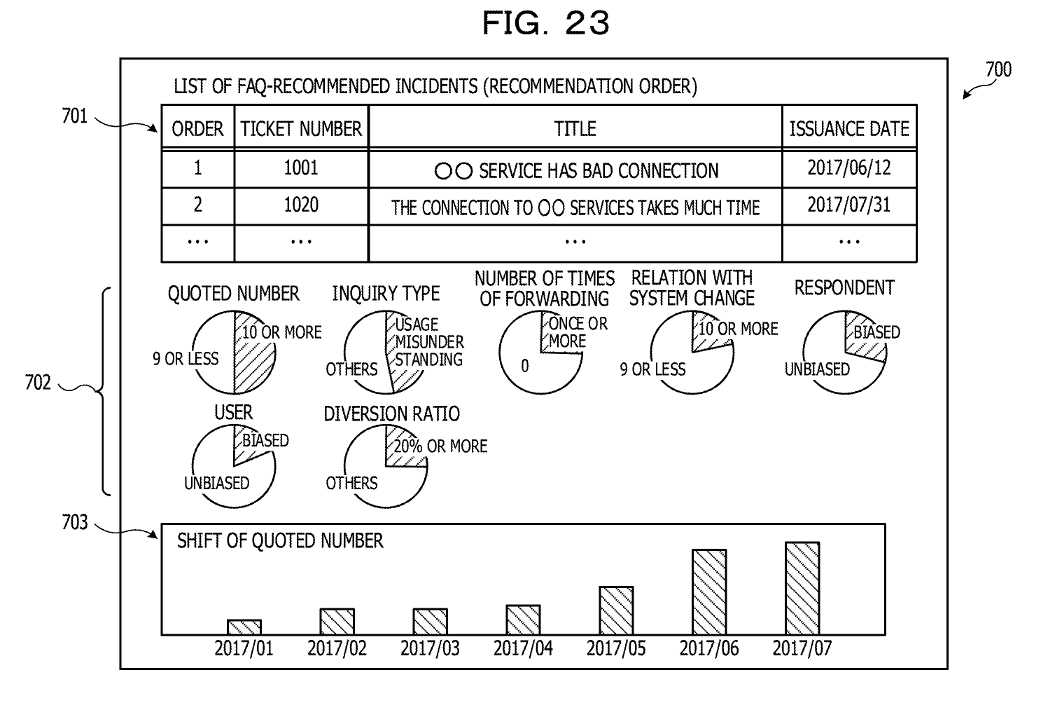

FIG. 23 is a view illustrating a display example of the analysis result screen. An analysis result screen 700 illustrated in FIG. 23 includes a registration candidate display section 701, a determination standard display section 702, and a quoted number display section 703.

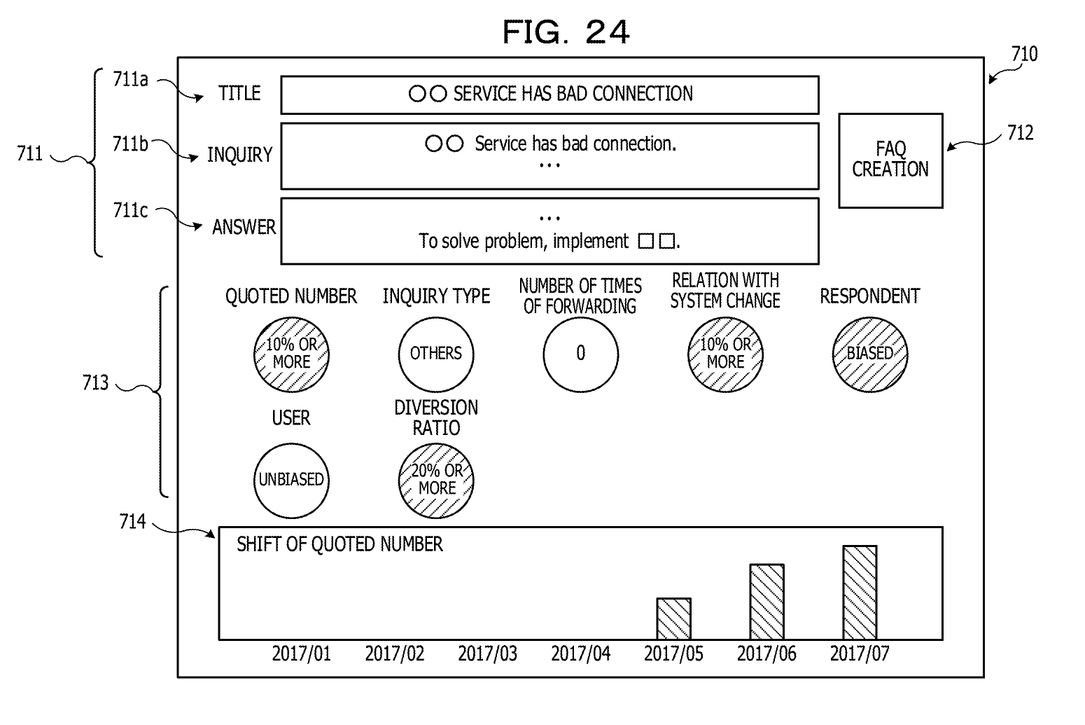

A list of a predetermined number of incident tickets having a high level of suitability is displayed in the registration candidate display section 701. In the example illustrated in FIG. 23, ticket number, title, and issue date are displayed as information on the incident tickets. When any one of the incident tickets is selected, a ticket content display screen presenting contents and analysis results of the selected incident ticket is displayed. An example of the ticket content display screen is described with reference to FIG. 24.

Circle graphs presenting what ratio of the incident tickets to the incident tickets collected for one year satisfies the determination standards are displayed in the determination standard display section 702 for each determination standard. The determination standards are the above-mentioned point-addition determination standards A1 to A6 and the point-deduction determination standards B1, B2. For example, in the circle graph corresponding to the point-addition determination standard A1, the ratio of a predetermined quoted number (for example, “10”) or more incident tickets to the all of the incident tickets is displayed.

The number of incident tickets including the answer information created by quoting the answer information in other incident tickets among the incident tickets collected for one year is displayed on a monthly basis in the quoted number display section 703.

FIG. 24 is a view illustrating a display example of a ticket content display screen. A ticket content display screen 710 illustrated in FIG. 24 includes a ticket content display section 711, a FAQ creation button 712, a determination standard display section 713, and a quoted number display section 714.

Contents of the selected incident ticket are displayed in the ticket content display section 711. In the example illustrated in FIG. 24, the ticket content display section 711 includes a title display section 711a for displaying the title of the incident ticket, an inquiry display section 711b for displaying contents of the inquiry information, and an answer display section 711c for displaying contents of the answer information.

The FAQ creation button 712 is an operational button for creating the FAQ based on contents of the displayed incident ticket. For example, when the analyzer presses the FAQ creation button 712, a FAQ creation screen not illustrated is displayed. The inquiry information and the answer information in the incident ticket are displayed on the FAQ creation screen, enabling the analyzer to edit contents of the inquiry information and the answer information. Then, when the analyzer presses a predetermined operational button on the FAQ creation screen, the FAQ including the displayed inquiry information and answer information (edited information if edited) is created and registered in the FAQ database 111.

Display information indicating whether or not the selected incident ticket satisfies each of the determination standards is displayed in the determination standard display section 713. In the determination standard display section 713, like the determination standard display section 702 on the analysis result screen 700, the display information for each determination standard is displayed in a circle graph. Each display information is color-coded depending on whether or not the determination standard is satisfied, and employs the same color in the determination standard display section 702. The analyzer may visually compare the determination standard display section 702 with the determination standard display section 713, to compare the tendency that the determination standard is satisfied at any ratio to the whole incident tickets with the tendency that the selected incident ticket satisfies the determination standard.

The number of times the selected incident ticket is quoted at the creation of the answer information in other incident tickets is displayed on a monthly basis in the quoted number display section 714. The analyzer may visually compare the quoted number display section 703 with the quoted number display section 714, to compare the shift of the quoted number in the whole incident tickets with the shift of the quoted number of the selected incident ticket.

Processing functions of the apparatuses in above-mentioned embodiments (for example, the information processor 1, the operation management server 100, and the analysis server 200) may be implemented by a computer. In this case, a program describing processing contents of the functions in the apparatuses is provided, and the program is performed by the computer to implement the processing functions on the computer. The program describing the processing contents may be recorded in a computer-readable recording medium. Examples of the computer-readable recording medium include a magnetic memory, an optical disc, a magneto-optical recording medium, and a semiconductor memory. Examples of the magnetic memory include a hard disc device (HDD), a flexible disc (FD), and a magnetic tape. Examples of the optical disc include a digital versatile disc (DVD), a DVD-RAM, a compact disc-read only memory (CD-ROM), and a CD-R (Recordable)/RW (ReWritable). Examples of the magneto-optical recording medium include a magneto-optical disk (MO).

To put the program into circulation, for example, a portable recording medium, such as DVD and CD-ROM, which records the program is sold. The program may be stored in a memory of a server computer, and may be also transferred from the server computer to other computers via a network.

For example, the computer stores the program recorded in the portable recording medium or the program transferred from the server computer in its own memory. Then, the computer reads the program from its own memory, and executes processing according to the program. Also, the computer directly may read the program from the portable recording medium, and execute the processing according to the program. Further, each time the program is transferred from the server computer connected via the network, the computer may execute the processing according to the transferred program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An analysis apparatus for reception information, the analysis apparatus comprising:
one or more memories configured to store a plurality of pieces of reception information and a plurality of pieces of maintenance information in association with each other, each of the plurality of pieces of reception information including inquiry information on an information processing system and answer information created to the inquiry information, each of the plurality of pieces of maintenance information representing contents of a maintenance operation performed on the information processing system; and
one or more processors coupled to the one or more memories and the one or more processors configured to
perform identifying a number N which indicates how many pieces of reception information are associated with first maintenance information which is stored in association with first reception information in the one or more memories, and
perform calculation of an evaluation value of the first reception information on the basis of the identified the number N, the evaluation value indicating suitability of registration of the reception information as knowledge.

2. The analysis apparatus according to claim 1, wherein the processor is further configured to register the first reception information as the knowledge when the evaluation value satisfies a certain condition.

3. The analysis apparatus according to claim 1, wherein the evaluation value is calculated by the calculation in such a way that a first value of the evaluation value calculated when the number is no less than a threshold value is bigger than a second value of the evaluation value calculated when the number is less than the threshold value.

4. The analysis apparatus according to claim 1, wherein
the processor is further configured to identify a number of times that first answer information included in the first reception information is quoted in other answer information included in other reception information, and
the evaluation value is calculated on the basis of the number of times.

5. The analysis apparatus according to claim 4, wherein the evaluation value is calculated in such a way that a first value of the evaluation value calculated when the number of times is no less than a threshold value is higher than a second value of the evaluation value calculated when the number of times is less than the threshold value.

6. The analysis apparatus according to claim 4, wherein
the number of times includes a first number of times for a first period and a second number of times for a second period that is smaller than the first period,
the evaluation value is calculated to be higher when the first number of times is no less than a first threshold value and the second number of times is no less than a second threshold value that is lower than the first threshold value, and
the evaluation value is calculated to be lower when the first number of times is no less than the first threshold value and the second number of times is less than the second threshold value.

7. The analysis apparatus according to claim 1, wherein the evaluation value is calculated to be higher in the calculation when contents of first inquiry information included in the first reception information are caused by misunderstanding of an originator of the first inquiry information on usage of the information processing system.

8. The analysis apparatus according to claim 1, wherein the evaluation value is calculated to be higher in the calculation when first inquiry information included in the first reception information is transmitted from a first respondent to a second respondent upon creation of first answer information to the first inquiry information.

9. The analysis apparatus according to claim 1, wherein the evaluation value is calculated to be higher in the calculation when first answer information included in the first reception information is quoted in other answer information created by a respondent of the first answer information.

10. The analysis apparatus according to claim 1, wherein the evaluation value is calculated to be higher in the calculation when a certain ratio or more of first inquiry information included in the first reception information is diverted to second answer information included in second reception information in the plurality of pieces of reception information.

11. The analysis apparatus according to claim 1, wherein the evaluation value is calculated to be lower in the calculation when first answer information included in the first reception information is quoted in a plurality of pieces of answer information, and first threshold value or more pieces of inquiry information in a plurality of pieces of inquiry information corresponding to the plurality of answer information are issued by a same originator.

12. The analysis apparatus according to claim 1, wherein
the processor is further configured to
calculate a plurality of evaluation values corresponding to the plurality of pieces of reception information respectively, and
display at least one piece of reception information in the plurality of pieces of reception information in accordance with the calculated plurality of evaluation values.

13. A computer-implemented analysis method for reception information, the analysis method comprising:
identifying a number N which indicates how many pieces of reception information are associated with first maintenance information which is stored in association with first reception information in one or more memories by referring to the one or more memories storing a plurality of pieces of reception information and a plurality of pieces of maintenance information in association with each other, each of the plurality of pieces of reception information including inquiry information on an information processing system and answer information created to the inquiry information, each of the plurality of pieces of maintenance information representing contents of a maintenance operation performed on the information processing system; and
calculating an evaluation value of the first reception information on the basis of the identified number N, the evaluation value indicating suitability of registration of the reception information as knowledge.

14. The analysis method according to claim 13, further comprising:
registering the first reception information as the knowledge when the evaluation value satisfies a certain condition.

15. A non-transitory computer-readable medium storing an analysis instructions executable by a computer, the analysis instructions comprising:
instructions for identifying a number N which indicates how many pieces of reception information are associated with first maintenance information which is stored in association with first reception information in one or more memories by referring to the one or more memories storing a plurality of pieces of reception information and a plurality of pieces of maintenance information in association with each other, each of the plurality of pieces of reception information including inquiry information on an information processing system and answer information created to the inquiry information, each of the plurality of pieces of maintenance information representing contents of a maintenance operation performed on the information processing system; and
instructions for calculating an evaluation value of the first reception information on the basis of the identified number N, the evaluation value indicating suitability of registration of the reception information as knowledge.

16. The medium according to claim 15, the instructions further comprising:
instructions for registering the first reception information as the knowledge when the evaluation value satisfies a certain condition.
